(19) United States
(12) Patent Application Publication
(10) Pub. No.: US 2024/0339114 A1
(43) Pub. Date: Oct. 10, 2024

(54) VOICE COMMAND RECEIVING DEVICE, VOICE COMMAND RECEIVING METHOD, AND COMPUTER-READABLE STORAGE MEDIUM

(71) Applicant: JVCKENWOOD Corporation, Yokohama-shi (JP)

(72) Inventors: Ryohei Sunaga, Yokohama-shi (JP); Masakiyo Sakano, Yokohama-shi (JP)

(21) Appl. No.: 18/740,555

(22) Filed: Jun. 12, 2024

Related U.S. Application Data
(63) Continuation of application No. PCT/JP2022/035585, filed on Sep. 26, 2022.

(30) Foreign Application Priority Data
Dec. 23, 2021 (JP) 2021-209852
Jul. 28, 2022 (JP) 2022-120231
Aug. 25, 2022 (JP) 2022-134042
Aug. 25, 2022 (JP) 2022-134164
Aug. 25, 2022 (JP) 2022-134165

(51) Int. Cl. G10L 15/22; G10L 25/78

(52) U.S. Cl. CPC G10L 15/22; G10L 25/78; G10L 2025/783

(57) ABSTRACT

A voice command receiving device includes: a voice command receiving unit configured to receive a voice command; a detection unit configured to, in an environment in which the voice command is uttered, detect a condition leading to a situation in which a voice command is not properly recognizable; and an implementation control unit configured to, when the voice command receiving unit receives a voice command, implement a function with respect to the received voice command. The voice command receiving unit is configured to receive a voice command at a voice recognition rate based on absence or presence of a condition leading to a situation in which a voice command is not properly recognizable.

### CROSS-REFERENCE TO RELATED APPLICATIONS

This application is a Continuation of PCT International Application No. PCT/JP2022/035585 filed on Sep. 26, 2022 which claims the benefit of priority from Japanese Patent Application No. 2021-209852 filed on Dec. 23, 2021, Japanese Patent Application No. 2022-120231 filed on Jul. 28, 2022, Japanese Patent Application No. 2022-134042 filed on Aug. 25, 2022, Japanese Patent Application No. 2022-134164 filed on Aug. 25, 2022 and Japanese Patent Application No. 2022-134165 filed on Aug. 25, 2022, the entire contents of all of which are incorporated herein by reference.

### BACKGROUND

The application concerned relates to a voice command receiving device, a voice command receiving method, and a computer-readable storage medium.

The devices that perform operations based on voice commands are becoming more diverse. For example, as far as the vehicle traveling data recorders are concerned, that is, as far as, what is called, dashboard cameras are concerned; there are devices that not only perform shock detection using an acceleration sensor but also perform event recording based on voice commands (for example, refer to DRV-MR760 [searched on Dec. 20, 2021], Internet (URL: https://www.kenwood.com/jp/car/drive-recorders/products/drv-mr760/)). As far as voice-command-based event recording is concerned, in the case of recording an accident in which the concerned vehicle is not involved, the event recording can be performed in a safe manner without requiring any operation of the touch-sensitive panel while driving. In Japanese Patent Application Laid-open No. 2020-154904 is disclosed a dashboard camera that performs event recording when a voice instruction is given about acceleration-based event detection.

In regard to a voice command that is issued to instruct a dashboard camera to perform event recording, the setting is done in advance in such a way that, for example, a voice command such as “Ro⋅Ku⋅Ga⋅Ka⋅I⋅Shi” (in Japanese, means “start of recording”) can be received. In order to prevent false detection of voice commands occurring due to other sounds, a voice command is required to be configured with a certain number of syllables. For example, “Ro⋅Ku⋅Ga⋅Ka⋅I⋅Shi” (in Japanese) has six syllables. Hence, in order to ensure that the voice command is recognized accurately, the utterer often utters a voice command by facing in the direction of the dashboard camera, that is, in the direction of a microphone that is provided for inputting the uttered voice of the voice command. A commonly-used dashboard camera is installed in the front of the vehicle when viewed from the passenger who represents the utterer. Hence, a voice command that is input while facing in the anterior direction, which represents the travelling direction of the vehicle, is recognized properly.

However, when a voice command is uttered in a situation in which it would not be properly recognized; due to a decline in the voice recognition rate for voice commands, there are times when an instruction given via a voice command is not received. In such a case, for example, regarding a voice command meant for instructing an operation requiring urgency or immediacy, such as a voice command for performing event recording in the dashboard camera; rephrasing of the voice command causes a delay in the operation. A situation in which a voice command is not properly recognizable can be, for example, a case in which the person uttering a voice command is not facing in the direction of the microphone that collects the uttered voices of voice commands. Such a situation can occur in various conditions explained in the application concerned.

### SUMMARY

A voice command receiving device according to one aspect of the present disclosure includes: a voice command receiving unit configured to receive a voice command; a detection unit configured to, in an environment in which the voice command is uttered, detect a condition leading to a situation in which a voice command is not properly recognizable; and an implementation control unit configured to, when the voice command receiving unit receives a voice command, implement a function with respect to the received voice command. The voice command receiving unit is configured to: when the detection unit determines absence of a condition leading to a situation in which a voice command is not properly recognizable, receive a voice command at a voice recognition rate, which is regarding voice commands acquired by the voice command receiving unit, equal to or greater than a first threshold value; and when the detection unit determines presence of a condition leading to a situation in which a voice command is not properly recognizable, receive a voice command at a voice recognition rate, which is regarding voice commands acquired by the voice command receiving unit, equal to or greater than a second threshold value that is smaller than the first threshold value.

A voice command receiving method according to another aspect of the present disclosure is implemented in a voice command receiving device, and includes: detecting, in an environment in which a voice command is uttered, a condition leading to a situation in which a voice command is not properly recognizable; receiving, when it is determined to have absence of a condition leading to a situation in which a voice command is not properly recognizable, a voice command at a voice recognition rate, which is regarding the voice command, equal to or greater than a first threshold value; receiving, when it is determined to have presence of a condition leading to a situation in which a voice command is not properly recognizable, a voice command at a voice recognition rate, which is regarding the voice command, equal to or greater than a second threshold value that is smaller than the first threshold value; and implementing, when the voice command is received, a function with respect to the received voice command.

A non-transitory computer-readable storage medium according to still another aspect of the present disclosure stores a computer program causing a computer to execute: detecting, in an environment in which a voice command is uttered, a condition leading to a situation in which a voice command is not properly recognizable; receiving, when it is determined to have absence of a condition leading to a situation in which a voice command is not properly recognizable, a voice command at a voice recognition rate, which is regarding the voice command, equal to or greater than a first threshold value; receiving, when it is determined to have presence of a condition leading to a situation in which a voice command is not properly recognizable, a voice command at a voice recognition rate, which is regarding the voice command, equal to or greater than a second threshold value that is smaller than the first threshold value; and implementing, when the voice command is received, a function with respect to the received voice command.

### BRIEF DESCRIPTION OF THE DRAWINGS

FIG. 1 is a block diagram illustrating an exemplary configuration of a recording device according to a first embodiment;

FIG. 2 is a flowchart for explaining a flow of the operations that are performed by a control unit according to the first embodiment;

FIG. 3 is a block diagram illustrating an exemplary configuration of a recording device according to a second embodiment;

FIG. 4 is a flowchart for explaining a flow of the operations that are performed by a control unit according to the second embodiment;

FIG. 5 is a flowchart for explaining a flow of the operations that are performed by the control unit according to a third embodiment;

FIG. 6 is a flowchart for explaining a flow of the operations that are performed by the control unit according to a fourth embodiment;

FIG. 7 is a flowchart for explaining a flow of the operations that are performed by the control unit according to a fifth embodiment;

FIG. 8 is a flowchart for explaining a flow of the operations that are performed by the control unit according to a sixth embodiment;

FIG. 9 is a block diagram illustrating an exemplary configuration of a recording device according to a seventh embodiment;

FIG. 10 is a flowchart for explaining a flow of the operations that are performed by a control unit according to the seventh embodiment;

FIG. 11 is a block diagram illustrating an exemplary configuration of a voice command receiving device according to an eighth embodiment;

FIG. 12 is a flowchart for explaining a flow of the operations that are performed by the voice command receiving device according to the eighth embodiment;

FIG. 13 is a flowchart for explaining a flow of the operations that are performed by the voice command receiving device according to a ninth embodiment;

FIG. 14 is a flowchart for explaining a flow of the operations that are performed by the voice command receiving device according to a tenth embodiment;

FIG. 15 is a flowchart for explaining a flow of the operations that are performed by the voice command receiving device according to an eleventh embodiment;

FIG. 16 is a flowchart for explaining a flow of the operations that are performed by the voice command receiving device according to a twelfth embodiment; and

FIG. 17 is a flowchart for explaining a flow of the operations that are performed by the voice command receiving device according to a thirteenth embodiment.

### DETAILED DESCRIPTION

Exemplary embodiments of the application concerned are described below in detail with reference to the accompanying drawings. However, the application concerned is not limited by the embodiment described below. In the embodiments described below, identical constituent elements are referred to by the same reference numerals, and their explanation is not given repeatedly. A voice command receiving device according to the application concerned is assumed to be one or various types of devices that perform operations in response to voice commands. Thus, the device to be used as the voice command receiving device is not limited by the embodiments described below.

### First Embodiment

In a first embodiment, the explanation is given about a recording device that is used in a vehicle and that represents an example of a voice command receiving device.

### Recording Device

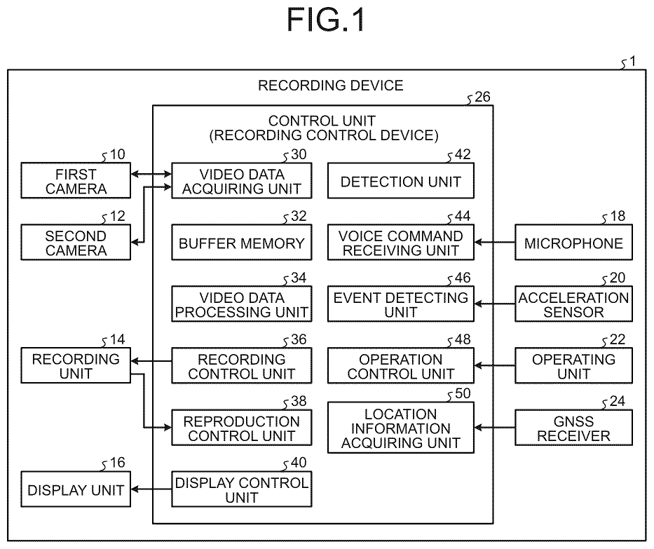

Explained below with reference to FIG. 1 is an exemplary configuration of the recording device according to the first embodiment. FIG. 1 is a block diagram illustrating an exemplary configuration of the recording device according to the first embodiment.

A recording device 1 is, what is called, a dashboard camera used for recording videos based on the events occurring with respect to the concerned vehicle. The recording device 1 either can be a device installed inside the vehicle, or can be a portable device usable in the vehicle. The recording device 1 can be configured to include the functions or the configuration of preinstalled devices in the vehicle or a navigation device of the vehicle. The recording device 1 performs an operation by which, depending on whether or not the passengers in the vehicle including the driver of the vehicle are facing in the travelling direction of the vehicle, the voice recognition rate for voice commands to be received is varied.

As illustrated in FIG. 1, the recording device 1 includes a first camera 10, a second camera 12, a recording unit 14, a display unit 16, a microphone 18, an acceleration sensor 20, an operating unit 22, a GNSS (Global Navigation Satellite System) receiver 24, and a control unit (a recording control device) 26. In the recording device 1; the first camera 10, the second camera 12, and the microphone 18 either can be included in an integrated manner or can be included as separate entities.

The first camera 10 takes photographs of the surrounding of the vehicle. As an example, the first camera 10 either can be configured as a camera that is specific to the recording device 1 or can be configured as a plurality of cameras each of which takes photographs in the front back direction. In the first embodiment, for example, the first camera 10 is configured using a plurality of cameras installed facing the anterior direction and the posterior direction of the vehicle; and takes photographs of the surrounding of the vehicle with the central focus on the anterior direction and the posterior direction of the vehicle. Alternatively, for example, the first camera 10 can be a singular camera capable of taking whole-sky photographs or half-sky photographs. The first camera 10 outputs first video data, which is acquired as a result of the photography, to a video data acquiring unit 30 of a control unit 26. The first video data represents, for example, a video configured with images having the frame rate of 30 frames per second.

The second camera 12 takes photographs of the interior of the vehicle. The second camera 12 is installed at such a position that at least the face region of the passengers in the vehicle can be captured. Herein, the passengers in the vehicle can include only the driver of the vehicle or can include other passengers along with the driver of the vehicle. The second camera 12 is installed, for example, either in the instrument panel of the vehicle or inside or around the rearview mirror of the vehicle. Regarding the second camera 12, the photographing range and the photographing orientation is fixed or almost fixed. The second camera 12 is configured using, for example, a visible light camera or a near-infrared camera.

Alternatively, for example, the second camera 12 can be configured by combining a visible light camera and a near-infrared camera. The second camera 12 outputs second video data, which is acquired as a result of the photography, to the video data acquiring unit 30 of the control unit 26. The second video data represents, for example, a video configured with images having the frame rate of 30 frames per second. When the first video data and the second video data need not be distinguished from each other, it is referred to as video data.

The first camera 10 and the second camera 12 can be configured as singular cameras capable of taking whole-sky photographs or half-sky photographs. In that case, in the video data formed by taking whole-sky photographs or half-sky photographs, the photographing range covering the entire video data or the surrounding of the vehicle or the photographing range covering the anterior side of the vehicle is treated as the first video data. Moreover, in the video data acquired by taking whole-sky photographs or half-sky photographs, the photographing range covering the faces of the passengers sitting on the seats in the vehicle is treated as the second video data. Thus, the entire video data acquired by taking whole-sky photographs or half-sky photographs can be treated as the first video data and the second video data.

The recording unit 14 is used to temporarily store the data of the recording device 1. Examples of the recording unit 14 include a semiconductor memory device such as a random access memory (RAM) or a flash memory; and a recording medium such as a memory card. Alternatively, the recording unit 14 can be an external recording unit connected in a wireless manner via a communication device (not illustrated). Based on a control signal output from the recording control unit 36 of the control unit 26, loop-recording video data or event data gets recorded in the recording unit 14.

The display unit 16 is, for example, a display device specific to the recording device 1 or a display device that is shared with some other system such as a navigation system. The display unit 16 can be configured in an integrated manner with the first camera 10. Herein, for example, the display unit 16 is a display such as a liquid crystal display (LCD) or an organic electro-luminescence (EL) display. In the first embodiment, the display unit 16 is installed on the anterior side of the vehicle, such as on the dashboard, on in the instrument panel, or on the center console. The display unit 16 is used to display videos based on the video signals output from the recording control unit 36 of the control unit 26. Herein, the display unit 16 is used to display the videos taken by the first camera 10 or the videos recorded in the recording unit 14.

The microphone 18 collects the sounds generated inside the vehicle. In the first embodiment, the microphone 18 is disposed at the position at which it is possible to collect the voices uttered by the passengers in the vehicle including the driver. For example, the microphone 18 is installed on the dashboard, or in the instrument panel, or the center console. The microphone 18 collects the voice regarding a voice command that is issued to the recording device 1. Then, the microphone 18 outputs the voice regarding the voice command to a voice command receiving unit 44. Thus, when the microphone 18 outputs the collected voice data to the video data acquiring unit 30, the recording control unit 36 can record loop-recording video data or event data that contains the concerned voice.

The acceleration sensor 20 detects the acceleration of the vehicle. Then, the acceleration sensor 20 outputs the detection result to an event detecting unit 46 of the control unit 26. Herein, for example, the acceleration sensor 20 detects triaxial acceleration. Herein, the triaxial directions indicate the front-back direction, the right-left direction, and the up-down direction of the vehicle.

The operating unit 22 is capable of receiving various operations with respect to the recording device 1. For example, the operating unit 22 is capable of receiving an operation of manually storing the captured video data as event data in the recording unit 14. Moreover, for example, the operating unit 22 is capable of receiving an operation for reproducing the loop-recording video data or the event data that has been recorded in the recording unit 14. Furthermore, for example, the operating unit 22 is capable of receiving an operation for deleting the event data that has been recorded in the recording unit 14. Moreover, for example, the operating unit 22 is capable of receiving an operation for ending the loop recording. Then, the operating unit 22 outputs operation information to an operation control unit 48 of the control unit 26.

The GNSS receiver 24 is configured using a GNSS receiver that receives GNSS signals from a GNSS satellite. The GNSS receiver 24 outputs the received GNSS signals to a location information acquiring unit 50 of the control unit 26.

The control unit 26 controls the constituent elements of the recording device 1. For example, the control unit 26 includes an information processing device such as a central processing unit (CPU) or a micro processing unit (MPU), and includes a memory device such as a random access memory (RAM) or a read only memory (ROM). The control unit 26 executes a computer program that controls the operations of the recording device 1 according to the application concerned. Alternatively, the control unit 26 can be implemented using, for example, an integrated circuit such as an application specific integrated circuit (ASIC) or a field programmable gate array (FPGA). Still alternatively, the control unit 26 can be implemented using a combination of hardware and software.

The control unit 26 includes the following as its configuration or as the function blocks implemented when a computer program is executed: the video data acquiring unit 30, a buffer memory 32, a video data processing unit 34, the recording control unit 36, a reproduction control unit 38, a display control unit 40, a detection unit 42, the voice command receiving unit 44, the event detecting unit 46, the operation control unit 48, and the location information acquiring unit 50.

The video data acquiring unit 30 acquires the first video data that is acquired as a result of taking photographs of the surrounding of the vehicle; and acquires the second video data that is acquired as a result of taking photographs of the inside of the vehicle. More particularly, the video data acquiring unit 30 acquires the first video data that is acquired using the first camera 10; and acquires the second video data that is acquired using the second camera 12. Then, the video data acquiring unit 30 outputs the first video data and the second video data to the buffer memory 32. Meanwhile, the first video data and the second video data that is acquired by the video data acquiring unit 30 is not limited to video-only data, and can contain video as well as audio. As the first video data and the second video data, the video data acquiring unit 30 can acquire video data that is acquired as a result of taking whole-sky photographs or half-sky photographs.

The buffer memory 32 represents the internal memory which is provided in the recording device 1 and in which the video data of a specific duration, which is acquired by the video data acquiring unit 30, is temporarily recorded while being updated.

The video data processing unit 34 converts the video data, which is temporarily stored in the buffer memory 32, into, for example, an arbitrary file format, such as the MP4 format, that is encoded according to an arbitrary codec method such as H.264 or MPEG-4 (MPEG stands for Moving Picture Experts Group). Herein, from the video data temporarily stored in the buffer memory 32, the video data processing unit 34 generates video data in the form of files covering a specific duration. As a specific example, the video data processing unit 34 generates the video data, which is temporarily stored in the buffer memory 32, as files of video data covering 60 seconds in order of recording. Then, the video data processing unit 34 outputs the generated video data to the recording control unit 36. Moreover, the video data processing unit 34 outputs the generated video data to the display control unit 40. Herein, although the duration of a set of video data generated as a file is set to 60 seconds as an example, that is not the only possible case.

The recording control unit 36 performs control to store the video data, which is in the form of files as acquired by conversion by the video data processing unit 34, in the recording unit 14. During the period of time of performing loop recording, such as when the accessory power of the vehicle is turned ON, the recording control unit 36 records the video data, which is in the form of files as acquired by conversion by the video data processing unit 34, as overwritable data in the recording unit 14. During the period of time of performing loop recording, the recording control unit 36 continuously records the video data, which is generated by the video data processing unit 34, in the recording unit 14; and, when the recording unit 14 becomes full in capacity, overwrites the oldest video data with the new video data.

When the voice command receiving unit 44 receives a voice command as an instruction to perform event recording, the recording control unit 36 stores, as event data, a first-set of video data in which the point of time of receiving the instruction to perform event recording is included. Then, the recording control unit 36 stores the event data as non-overwritable data in the recording unit 14. For example, the recording control unit 36 copies, from the buffer memory 32, the first video data of a predetermined period of time including about 10 seconds before and after the point of time at which the voice command receiving unit 44 receives a voice command indicating event detection; and stores the copied first video data as the event data.

When the event detecting unit 46 detects the occurrence of an event based on the output value of the acceleration sensor 20, the recording control unit 36 stores, as event data, the first video data in which the point of time of detection of the event is included. Herein, the recording control unit 36 stores the event data as non-overwritable data in the recording unit 14. For example, the recording control unit 36 copies, from the buffer memory 32, the first video data during a predetermined period of time including about 10 seconds before and after the point of time at which the event detecting unit 46 detected an event; and stores the copied first video data as the event data.

The reproduction control unit 38 reproduces the loop-recording video data or the event data, which has been recorded in the recording unit 14, based on the control signal of a reproduction operation as output from the operation control unit 48; and performs control to cause the display control unit 40 to output the reproduced video in the display unit 16.

The display control unit 40 controls the display of the video data in the display unit 16. The display control unit 40 outputs a video signal meant for outputting the video data in the display unit 16. More specifically, the display control unit 40 outputs the video taken by the first camera 10 or outputs a video signal meant for displaying the loop-recording video data or the event data, which has been recorded in the recording unit 14, by means of reproduction.

The detection unit 42 detects, in the environment in which voice commands are uttered, the conditions that lead to a situation in which a voice command is not properly recognizable. In the first embodiment, the detection unit 42 detects the orientation of the face of the person who uttered a voice command. The condition in which the orientation of the person who uttered a voice command is not in the direction of the microphone, which acquires the uttered voice of a voice command, can be treated as a condition that causes a situation in which a voice command is not properly recognizable. For that reason, the detection unit 42 recognizes the passengers in the vehicle from the second video data. In the first embodiment, the passengers include the driver as well as the other occupants other than the driver. Alternatively, the driver of the vehicle can be the only passenger in the vehicle. The detection unit 42 recognizes the face of a person from the second video data and detects the orientation of the face. For example, the detection unit 42 detects the face of a person based on the positional relationship of the feature regions constituting the face of the person, and detects the orientation of the face from the positional relationship of the elements constituting the face, such as the central line of the face. As far as the detection method is concerned, it is possible to implement a known method without any particular restriction.

The detection unit 42 detects the orientation of the face of the passenger in the vehicle from the second video data, and determines whether or not the passenger in the vehicle is facing in the direction in which the microphone 18 can properly collect the voice of that passenger. For example, the detection unit 42 detects the orientation of the face of the passenger in the vehicle from the second video data, and determines whether the passenger is facing in the travelling direction of the vehicle or is facing in some other direction other than the travelling direction. Regarding the travelling direction of the vehicle, for example, when the state in which the passenger is facing in the anterior direction of the vehicle is considered to have the angle of 0°, the direction including the range of about ±30° is treated as the travelling direction.

In the first embodiment, it is explained that the detection unit 42 detects whether the passenger in the vehicle is facing in the travelling direction of the vehicle or is facing in some other direction other than the travelling direction. However, the application concerned is not limited by that case. For example, the detection unit 42 can determine from the second video data about whether the passenger in the vehicle is facing in the direction of the microphone 18 or is facing in some other direction other than the direction of the microphone 18.

Moreover, for example, the detection unit 42 detects the presence or absence of an object that is covering the mouth region of the person who uttered a voice command. The condition in which an object is covering the mouth region of the person who uttered a voice command can be treated as a condition that causes a situation in which a voice command is not properly recognizable. For that reason, the detection unit 42 confirms the passenger in the vehicle from the second video data. In the first embodiment, the passengers include the driver as well the other occupants other than the driver. Alternatively, the driver of the vehicle can be the only passenger in the vehicle. The detection unit 42 recognizes the face of the person from the second video data and detects the presence or absence of an object covering the mouth portion of that person. An object covering the mouth region of a person not only includes an object covering the mouth region but also includes an object covering the lower half of the face of the person. For example, the detection unit 42 performs an object recognition operation using dictionary data, and detects the presence or absence of a mask that covers the mouth region of the person. As far as the detection method for detecting an object covering the mouth region of a person is concerned, it is possible to implement a known method without any particular restriction.

Furthermore, for example, the detection unit 42 detects the volume level of the background sound in the environment in which voice commands are received. Herein, the background sound in the environment in which voice commands are received represents the ambient sound coming from the inside and the outside of the vehicle, and can include: the advertisement sounds coming from the inside and the outside of the vehicle; the exhaust sound or the audio coming from other vehicles; the reverberations occurring inside a tunnel; and the audio inside the concerned vehicle. The condition in which the volume level of the background sound in the environment in which voice commands are received is equal to or greater than a predetermined level can be treated as a condition that causes a situation in which a voice command is not properly recognizable. Regarding the volume level of the background sound in the environment in which voice commands are received, the predetermined value is, for example, equal to 70 dB. The detection unit 42 detects the background sound from the sounds collected by the microphone 18. Moreover, the detection unit 42 detects the volume level of the detected background sound. For example, the detection unit 42 can perform feature quantity analysis with respect to the sounds collected by the microphone 18, and can detect the sounds other than the utterance of a voice command, which is extracted by the voice command receiving unit 44, as the background sound. As far as the method for detecting the background sound and the volume level of the background sound is concerned, it is possible to implement a known method without any particular restriction.

Moreover, for example, the detection unit 42 detects the volume level of an uttered voice. The condition in which the volume level of the uttered voice of a voice command is lower than a predetermined level can be treated as a condition that causes a situation in which a voice command is not properly recognizable. Regarding the volume level of the uttered voice of a voice command, the predetermined value is, for example, equal to, 50 dB. The detection unit 42 detects the volume level of the uttered voice of a voice command collected by the microphone 18. As far as the method for detecting the voice level of an uttered voice is concerned, it is possible to implement a known method without any particular restriction.

Furthermore, for example, the detection unit 42 detects the volume level difference between the background sound in the environment in which voice commands are received and the volume level of the uttered voice of the voice command. The condition in which the volume level difference between the background sound in the environment in which voice commands are received and the volume level of the uttered voice of the voice command is lower than a predetermined value can be treated as a condition that causes a situation in which a voice command is not properly recognizable. Moreover, The condition in which the volume level difference between the background sound in the environment in which voice commands are received and the volume level of the uttered voice of the voice command is equal to or higher than a predetermined value and the condition in which the volume level of the background sound is higher than the volume level of the uttered voice can be treated as the conditions that cause a situation in which a voice command is not properly recognizable. In that case, the volume level difference is, for example, in the approximate range from 15 dB to 20 dB. As far as the method for detecting the volume level difference between the background sound in the environment in which voice commands are received and the volume level of the uttered voice of the voice command is concerned, it is possible to implement a known method without any particular restriction.

The detection unit 42 detects, in the environment in which voice commands are uttered, the condition that causes a situation in which a voice command is not properly recognizable. In the first embodiment, the detection unit 42 detects the distance between the microphone 18 and the person who uttered a voice command. The condition in which the distance between the microphone 18 and the person who uttered a voice command is equal to or longer than a predetermined distance can be treated as a condition that causes a situation in which a voice command is not properly recognizable. The predetermined distance can be set to, for example, 1.0 m. However, that is not the only possible case. For example, inside the vehicle, the predetermined distance is calculated based on the seating position. For example, when the passenger sitting in the front seat is the utterer, the detection unit 42 detects that the distance between the microphone 18 and the utterer is shorter than the predetermined distance. Moreover, for example, when the passenger sitting in a rear seat is the utterer, the detection unit 42 detects that the distance between the microphone 18 and the utterer is shorter than the predetermined distance. For that reason, the detection unit 42 recognizes the passengers in the vehicle from the second video data. In the first embodiment, the passengers include the driver as well the other occupants other than the driver. Alternatively, the driver of the vehicle can be the only passenger in the vehicle. The detection unit 42 recognizes the face of a person from the second video data. As far as the method for detecting the distance between the microphone 18 and the person who uttered a voice command is concerned, it is possible to implement a known method without any particular restriction.

The voice command receiving unit 44 recognizes the sounds collected by the microphone 18, and accordingly receives a voice command. For example, the voice command receiving unit 44 performs sound source separation and voice recognition with respect to the sounds collected by the microphone 18, and recognizes a voice command issued for starting the event recording. The voice command for starting the event recording is, for example, “Ro⋅Ku⋅Ga⋅Ka⋅I⋅Shi” (in Japanese). When the six consecutive syllables “Ro⋅Ku⋅Ga⋅Ka⋅I⋅Shi” (in Japanese) are recognized in the sounds collected by the microphone 18, the voice command receiving unit 44 outputs a control signal, which is meant for starting an event recording operation, to the recording control unit 36. Alternatively, when a voice indicating the word “RokuGaKaIShi” (in Japanese) is recognized in the sounds collected by the microphone 18, the voice command receiving unit 44 outputs a control signal, which is meant for starting an event recording operation, to the recording control unit 36. Meanwhile, depending on whether or not the passenger in the vehicle is facing in the travelling direction, that is, in the direction of the microphone 18 used for acquiring the uttered voice of a voice command, the voice command receiving unit 44 varies the voice recognition rate meant for determining whether or not a voice command is acquired.

In a situation in which a voice command is properly recognizable, such as when the passenger in the vehicle is facing in the travelling direction of the vehicle; if all of the six consecutive syllables “Ro⋅Ku⋅Ga⋅Ka⋅I⋅Shi” (in Japanese) are matching, then the voice command receiving unit 44 determines that a voice command is acquired. For example, the voice command receiving unit 44 sets the voice recognition rate, which is meant for determining that a voice command is acquired, to a first threshold value of 90%. In that case, from among the six syllables “Ro⋅Ku⋅Ga⋅Ka⋅I⋅Shi” (in Japanese), when 90% or more syllables can be recognized, the voice command receiving unit 44 determines that a voice command is acquired.

On the other hand, in a situation in which a voice command is not properly recognizable, such as when the passenger in the vehicle is facing in some other direction other than the travelling direction of the vehicle; if five or more of the six consecutive syllables “Ro⋅Ku⋅Ga⋅Ka⋅I⋅Shi” (in Japanese) are matching, then the voice command receiving unit 44 determines that a voice command is acquired. In that case, the voice command receiving unit 44 sets the voice recognition rate, which is meant for determining that a voice command is acquired, to a second threshold value that is smaller than the first threshold value. For example, the voice command receiving unit 44 sets the second threshold value to 80%. In that case, from among the six consecutive syllables “Ro⋅Ku⋅Ga⋅Ka⋅I⋅Shi” (in Japanese), when 80% or more syllables can be recognized, the voice command receiving unit 44 determines that a voice command is acquired. Thus, in a situation in which a voice command is not properly recognizable, such as when the passenger in the vehicle is facing in some other direction other than the travelling direction of the vehicle; even if the utterance of the passenger cannot be recognized in totality, it is determined that a voice command has been uttered, thereby resulting in proper recognition of the voice command.

Meanwhile, when the passenger in the vehicle is facing in the travelling direction of the vehicle, the voice command receiving unit 44 sets the agreement rate between the acoustic model of the speech waveform indicating the word “RokuGaKaIShi” (in Japanese) and the waveform of the input voice to, for example, 90% as the first threshold value of the voice recognition rate meant for determining that a voice command is acquired. In that case, if the agreement rate between the acoustic model of the speech waveform indicating the word “RokuGaKaIShi” (in Japanese) and the waveform of the input voice is equal to or greater than 90%, then the voice command receiving unit 44 determines that a voice command is acquired.

On the other hand, when the passenger in the vehicle is facing in some other direction other than the travelling direction of the vehicle, the voice command receiving unit 44 sets the agreement rate between the acoustic model of the speech waveform indicating the word “RokuGaKaIShi” (in Japanese) and the waveform of the input voice to, for example, 80% as the second threshold value that is smaller than the first threshold value of the voice recognition rate meant for determining that a voice command is acquired. In that case, if the agreement rate between the acoustic model of the speech waveform indicating the word “RokuGaKaIShi” (in Japanese) and the waveform of the input voice is equal to or greater than 80%, then the voice command receiving unit 44 determines that a voice command is acquired. That is, when the passenger in the vehicle is facing in some other direction other than the travelling direction of the vehicle, it becomes easier to recognize the voice of the passenger as a voice command.

Meanwhile, depending on whether or not the mouth region of the passenger in the vehicle is covered by an object, the voice command receiving unit 44 varies the voice recognition rate meant for determining whether or not a voice command is acquired.

In a situation in which a voice command is properly recognizable, such as when the mouth region of the passenger in the vehicle is not covered by an object; if all of the six consecutive syllables “Ro⋅Ku⋅Ga⋅Ka⋅I⋅Shi” (in Japanese) are matching, then the voice command receiving unit 44 determines that a voice command is acquired. For example, the voice command receiving unit 44 sets the voice recognition rate, which is meant for determining that a voice command is acquired, to the first threshold value of 90%. In that case, from among the six syllables “Ro⋅Ku⋅Ga⋅Ka⋅I⋅Shi” (in Japanese), when 90% or more syllables can be recognized, the voice command receiving unit 44 determines that a voice command is acquired.

On the other hand, in a situation in which a voice command is not properly recognizable, such as when the mouth region of the passenger in the vehicle is covered by an object; if five or more of the six consecutive syllables “Ro⋅Ku⋅Ga⋅Ka⋅I⋅Shi” (in Japanese) are matching, then the voice command receiving unit 44 determines that a voice command is acquired. In that case, the voice command receiving unit 44 sets the voice recognition rate, which is meant for determining that a voice command is acquired, to the second threshold value that is smaller than the first threshold value. For example, the voice command receiving unit 44 sets the second threshold value to 80%. In that case, from among the six consecutive syllables “Ro⋅Ku⋅Ga⋅Ka⋅I⋅Shi” (in Japanese), when 80% or more syllables can be recognized, the voice command receiving unit 44 determines that a voice command is acquired. Thus, in a situation in which a voice command is not properly recognizable, such as when the mouth region of the passenger in the vehicle is covered by an object; even if the utterance of the passenger cannot be recognized in totality, it is determined that a voice command has been uttered, thereby resulting in proper recognition of the voice command.

Meanwhile, when the mouth region of the passenger in the vehicle is not covered by an object, the voice command receiving unit 44 sets the agreement rate between the acoustic model of the speech waveform indicating the word “RokuGaKaIShi” (in Japanese) and the waveform of the input voice to, for example, 90% as the first threshold value of the voice recognition rate meant for determining that a voice command is acquired. In that case, if the agreement rate between the acoustic model of the speech waveform indicating the word “RokuGaKaIShi” (in Japanese) and the waveform of the input voice is equal to or greater than 90%, then the voice command receiving unit 44 determines that a voice command is acquired.

On the other hand, when the mouth region of the passenger in the vehicle is covered by an object, the voice command receiving unit 44 sets the agreement rate between the acoustic model of the speech waveform indicating the word “RokuGaKaIShi” (in Japanese) and the waveform of the input voice to, for example, 80% as the second threshold value that is smaller than the first threshold value of the voice recognition rate meant for determining that a voice command is acquired. In that case, if the agreement rate between the acoustic model of the speech waveform indicating the word “RokuGaKaIShi” (in Japanese) and the waveform of the input voice is equal to or greater than 80%, then the voice command receiving unit 44 determines that a voice command is acquired. That is, when the mouth region of the passenger in the vehicle is covered by an object, it becomes easier to recognize the voice of the passenger as a voice command.

Moreover, according to the volume level of the background sound in the environment in which voice commands are received or according to the volume level of the uttered voice of a voice command, the voice command receiving unit 44 varies the voice recognition rate meant for determining whether or not a voice command is acquired.

In a situation in which a voice command is properly recognizable, such as when the volume level of the background sound is lower than a predetermined value; if all of the six consecutive syllables “Ro⋅Ku⋅Ga⋅Ka⋅I⋅Shi” (in Japanese) are matching, then the voice command receiving unit 44 determines that a voice command is acquired. For example, the voice command receiving unit 44 sets the voice recognition rate, which is meant for determining that a voice command is acquired, to the first threshold value of 90%. In that case, from among the six syllables “Ro⋅Ku⋅Ga⋅Ka⋅I⋅Shi” (in Japanese), when 90% or more syllables can be recognized, the voice command receiving unit 44 determines that a voice command is acquired. Moreover, when the volume level of the uttered voice of a voice command is equal to or greater than a predetermined value, the voice command receiving unit 44 sets the voice recognition rate, which is meant for determining that a voice command is acquired, to the first threshold value. Furthermore, when the volume level difference between the background sound in the environment in which voice commands are received and the volume level of the uttered voice of a voice command is equal to or greater than a predetermined value and when the volume level of the uttered voice is higher than the volume level of the background sound, the voice command receiving unit 44 sets the voice recognition rate, which is meant for determining that a voice command is acquired, to the first threshold value. That is, when the volume level of the uttered voice is higher than the volume level of the background sound by a volume level difference equal to or greater than a predetermined value, the voice command receiving unit 44 sets the voice recognition rate, which is meant for determining that a voice command is acquired, to the first threshold value.

On the other hand, in a situation in which a voice command is not properly recognizable, such as when the volume level of the background sound is equal to or greater than a predetermined value; if five or more of the six consecutive syllables “Ro⋅Ku⋅Ga⋅Ka⋅I⋅Shi” (in Japanese) are matching, then the voice command receiving unit 44 determines that a voice command is acquired. In that case, the voice command receiving unit 44 sets the voice recognition rate, which is meant for determining that a voice command is acquired, to the second threshold value that is smaller than the first threshold value. For example, the voice command receiving unit 44 sets the second threshold value to 80%. In that case, from among the six consecutive syllables “Ro⋅Ku⋅Ga⋅Ka⋅I⋅Shi” (in Japanese), when 80% or more syllables can be recognized, the voice command receiving unit 44 determines that a voice command is acquired. Thus, in a situation in which a voice command is not properly recognizable, such as when the volume level of the background sound in the environment in which voice commands are received is equal to or greater than a predetermined value; even if the utterance of the passenger cannot be recognized in totality, it is determined that a voice command has been uttered, thereby resulting in proper recognition of the voice command. Moreover, when the volume level of the uttered voice of a voice command is lower than a predetermined value, the voice command receiving unit 44 sets the voice recognition rate, which is meant for determining that a voice command, to the second threshold value. Furthermore, when the volume level difference between the background sound in the environment in which voice commands are received and the volume level of the uttered voice of the voice command is equal to or higher than a predetermined value and when the volume level of the background sound is higher than the volume level of the uttered voice, the voice command receiving unit 44 sets the voice recognition rate, which is meant for determining that a voice command is acquired, to the second threshold value. That is, when the volume level of the background sound is higher than the volume level of the uttered voice by a volume level difference equal to or greater than a predetermined value, the voice command receiving unit 44 sets the voice recognition rate, which is meant for determining that a voice command is acquired, to the second threshold value.

On the other hand, if the volume level of the background sound is lower than a predetermined value, then the voice command receiving unit 44 sets the agreement rate between the acoustic model of the speech waveform indicating the word “RokuGaKaIShi” (in Japanese) and the waveform of the input voice to, for example, 90% as the first threshold value of the voice recognition rate meant for determining that a voice command is acquired. In that case, if the agreement rate between the acoustic model of the speech waveform indicating the word “RokuGaKaIShi” (in Japanese) and the waveform of the input voice is equal to or greater than 90%, then the voice command receiving unit 44 determines that a voice command is acquired. The same is the case when the volume level of the uttered voice of a voice command is equal to or greater than a predetermined value; and when the volume level difference between the background sound in the environment in which voice commands are received and the volume level of the uttered voice of a voice command is equal to or greater than a predetermined value and when the volume level of the uttered voice is higher than the volume level of the background sound.

On the other hand, when the volume level of the background sound is equal to or greater than a predetermined value, the voice command receiving unit 44 sets the agreement rate between the acoustic model of the speech waveform indicating the word “RokuGaKaIShi” (in Japanese) and the waveform of the input voice to, for example, 80% as the second threshold value that is smaller than the first threshold value of the voice recognition rate meant for determining that a voice command is acquired. In that case, if the agreement rate between the acoustic model of the speech waveform indicating the word “RokuGaKaIShi” (in Japanese) and the waveform of the input voice is equal to or greater than 80%, then the voice command receiving unit 44 determines that a voice command is acquired. That is, when the volume level of the background sound in the environment in which voice commands are received is equal to or greater than a predetermined value, it becomes easier to recognize the voice of the passenger as a voice command. The same is the case when the volume level of the uttered voice of the voice command is lower than a predetermined value; and when the volume level difference between the background sound in the environment in which voice commands are received and the volume level of the uttered voice of a voice command is equal to or higher than a predetermined value and when the volume level of the background sound is higher than the volume level of the uttered voice.

Meanwhile, in a situation in which a voice command is properly recognizable, such as when the distance between the microphone 18 and the person who uttered a voice command is shorter than a predetermined distance; if all of the six consecutive syllables “Ro⋅Ku⋅Ga⋅Ka⋅I⋅Shi” (in Japanese) are matching, then the voice command receiving unit 44 determines that a voice command is acquired. For example, the voice command receiving unit 44 sets the voice recognition rate, which is meant for determining that a voice command is acquired, to the first threshold value of 90%. In that case, from among the six syllables “Ro⋅Ku⋅Ga⋅Ka⋅I⋅Shi” (in Japanese), when 90% or more syllables can be recognized, the voice command receiving unit 44 determines that a voice command is acquired.

On the other hand, in a situation in which a voice command is not properly recognizable, such as when the distance between the microphone 18 and the person who uttered a voice command is equal to or longer than a predetermined distance; if five or more of the six consecutive syllables “Ro⋅Ku⋅Ga⋅Ka⋅I⋅Shi” (in Japanese) are matching, then the voice command receiving unit 44 determines that a voice command is acquired. In that case, the voice command receiving unit 44 sets the voice recognition rate, which is meant for determining that a voice command is acquired, to the second threshold value that is smaller than the first threshold value. For example, the voice command receiving unit 44 sets the second threshold value to 80%. In that case, from among the six consecutive syllables “Ro⋅Ku⋅Ga⋅Ka⋅I⋅Shi” (in Japanese), when 80% or more syllables can be recognized, the voice command receiving unit 44 determines that a voice command is acquired. Thus, in a situation in which a voice command is not properly recognizable, such as when the distance between the microphone 18 and the person who uttered a voice command is equal to or longer than a predetermined distance; even if the utterance of the passenger cannot be recognized in totality, it is determined that a voice command has been uttered, thereby resulting in proper recognition of the voice command.

Thus, depending on whether or not the distance between the microphone 18 and the person who uttered a voice command is equal to or longer than a predetermined distance, the voice command receiving unit 44 varies the voice recognition rate meant for determining whether or not a voice command is acquired.

When the distance between the microphone 18 and the person who uttered a voice command is shorter than a predetermined distance, the voice command receiving unit 44 sets the agreement rate between the acoustic model of the speech waveform indicating the word “RoKuGaKaIShi” (in Japanese) and the waveform of the input voice to, for example, 90% as the first threshold value of the voice recognition rate meant for determining that a voice command is acquired. In that case, if the agreement rate between the acoustic model of the speech waveform indicating the word “RokuGaKaIShi” (in Japanese) and the waveform of the input voice is equal to or greater than 90%, then the voice command receiving unit 44 determines that a voice command is acquired.

On the other hand, when the distance between the microphone 18 and the person who uttered a voice command is equal to or longer than a predetermined distance, the voice command receiving unit 44 sets the agreement rate between the acoustic model of the speech waveform indicating the word “RokuGaKaIShi” (in Japanese) and the waveform of the input voice to, for example, 80% as the second threshold value that is smaller than the first threshold value of the voice recognition rate meant for determining that a voice command is acquired. In that case, if the agreement rate between the acoustic model of the speech waveform indicating the word “RokuGaKaIShi” (in Japanese) and the waveform of the input voice is equal to or greater than 80%, then the voice command receiving unit 44 determines that a voice command is acquired. That is, when the distance between the microphone 18 and the person who uttered a voice command is equal to or longer than a predetermined distance, it becomes easier to recognize the voice of the passenger as a voice command.

The event detecting unit 46 detects an event based on the acceleration applied to the vehicle. If acceleration information indicates that the acceleration is equal to or greater than a preset threshold value corresponding to the collision of the vehicle, the event detecting unit 46 detects the occurrence of an event.

The operation control unit 48 acquires operation information of the operation received by the operating unit 22. For example, the operation control unit 48 acquires storage operation information indicating a manual storage operation performed to manually store the video data, acquires reproduction operation information indicating a reproduction operation, or acquires deletion operation information indicating a deletion operation performed to delete the video data; and accordingly outputs a control signal. For example, the operation control unit 48 acquires end operation information indicating an operation performed to end the loop recording, and accordingly outputs a control signal.

The operation control unit 48 receives an event recording operation attributed to a voice command that is recognized and received by the voice command receiving unit 44.

The location information acquiring unit 50 acquires location information indicating the present location of the vehicle. Based on the GNSS signal received by the GNSS receiver 24, the location information acquiring unit 50 calculates the location information of the present location of the vehicle according to a known method.

### Operations Performed by Control Unit

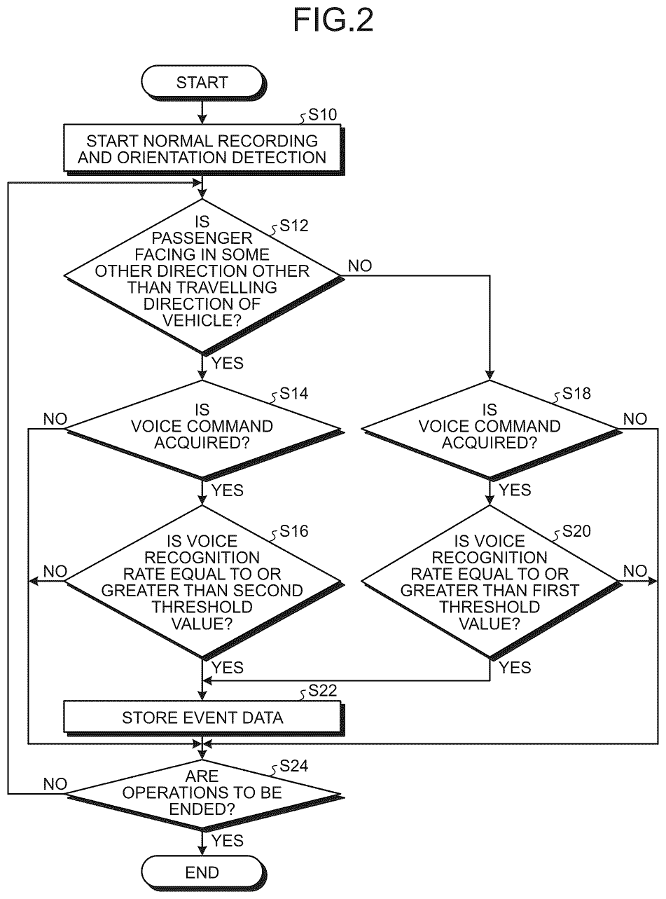

Explained below with reference to FIG. 2 is a flow of the operations that are performed by the control unit according to the first embodiment. FIG. 2 is a flowchart for explaining a flow of the operations that are performed by the control unit according to the first embodiment. The operations illustrated in FIG. 2 are started when the power of the engine of the vehicle, in which the recording device 1 is installed, is triggered.

At the start of the operations, the control unit 26 starts normal recording and orientation detection (Step S10). More particularly, the recording control unit 36 sends the video data, which is taken by the first camera 10 and the second camera 12, to the buffer memory 32; generates video files of videos each of which covers a predetermined period of time such as 60 seconds; and records the video files in the recording unit 14. The detection unit 42 starts the detection of the orientation of the face of the passenger in the vehicle. Then, the system control proceeds to Step S12.

The detection unit 42 determines whether or not the passenger in the vehicle is facing in some other direction other than the travelling direction of the vehicle (Step S12). More particularly, the detection unit 42 determines whether or not the passenger in the vehicle is facing in some other direction other than the travelling direction for a predetermined period of time or more. Herein, if the passenger in the vehicle is facing in some other direction other than the travelling direction only for a predetermined period of time or more, then the detection unit 42 determines that the passenger in the vehicle is facing in some other direction other than the travelling direction. The predetermined period of time is, for example, equal to or longer than two seconds. However, that is not the only possible case. When it is determined that the passenger in the vehicle is facing in some other direction other than the travelling direction (Yes at Step S12), the system control proceeds to Step S14. On the other hand, if it is not determined that the passenger in the vehicle is facing in some other direction other than the travelling direction (No at Step S12), then the system control proceeds to Step S18.

If the determination performed at Step S12 indicates an affirmative result, then the voice command receiving unit 44 determines whether or not the microphone 18 has acquired a voice command from the passenger in the vehicle (Step S14). If it is determined that a voice command is acquired (Yes at Step S14), then the system control proceeds to Step S16. On the other hand, if it is not determined that a voice command is acquired (No at Step S14), then the system control proceeds to Step S24.

If the determination performed at Step S14 indicates an affirmative result, then the voice command receiving unit 44 determines whether or not the voice recognition rate regarding the acquired voice command is equal to or greater than the second threshold value (Step S16). If it is determined that the voice recognition rate regarding the voice command is equal to or greater than the second threshold value (Yes at Step S16), then the system control proceeds to Step S22. On the other hand, if it is not determined that the voice recognition rate regarding the voice command is equal to or greater than the second threshold value (No at Step S16), then the system control proceeds to Step S24.

Meanwhile, if the determination performed at Step S12 indicates a negative result, then the voice command receiving unit 44 determines whether or not a voice command given by the passenger in the vehicle is acquired by the microphone 18 (Step S18). If it is determined that a voice command is acquired (Yes at Step S18), then the system control proceeds to Step S20. On the other hand, if it is not determined that a voice command is acquired (No at Step S18), then the system control proceeds to Step S24.

If the determination performed at Step S18 indicates an affirmative result, then the voice command receiving unit 44 determines whether or not the voice recognition rate for the acquired voice command is equal to or greater than the first threshold value (Step S20). If it is determined that the voice recognition rate for the voice command is equal to or greater than the first threshold value (Yes at Step S20), then the system control proceeds to Step S22. On the other hand, if it is not determined that the voice recognition rate for the voice command is equal to or greater than the first threshold value (No at Step S20), then the system control proceeds to Step S24. At Steps S14 and S18, in addition to determining whether or not a voice command is acquired, it can also be determined whether or not the acquired voice command has high urgency or high immediacy. In other words, at Steps S14 and S18, it is determined whether or not the voice command having high urgency or high immediacy is acquired. The voice command having high urgency or high immediacy implies a voice command that, when received, demands implementation of a function that is required to start its operations without delay. For example, in the recording device 1, a voice command having high urgency or high immediacy implies a voice command for instructing event recording.

If the determination performed at Step S16 or Step S20 indicates an affirmative result, then the recording control unit 36 stores the event data in the recording unit 14 (Step S22). More particularly, the recording control unit 36 stores, as event data in the recording unit 14, the first video data captured before and after the point of time at which the voice command receiving unit 44 receives a voice command. Then, the system control proceeds to Step S24.

Meanwhile, if the determination at any step from Step S14 to Step S20 indicates a negative result or after the operation at Step S22 is performed, the control unit 26 determines whether or not to end the operations (Step S24). More particularly, when an operation for switching off the power source of the operating unit 22 is received, or when an operation indicating the end of the operations is received, or when the power such as the engine of the vehicle in which the recording device 1 is installed is turned off; it is determined to end the operations. When it is determined to end the operations (Yes at Step S24), then the operations illustrated in FIG. 2 are ended. On the other hand, if it is not determined to end the operations (No at Step S24), then the system control proceeds to Step S12.

As explained above, in the first embodiment, the voice recognition rate meant for recognizing a voice as a voice command is varied depending on whether the passenger in the vehicle is facing in the travelling direction or is facing in some other direction other than the travelling direction; and then the event data is stored. In the first embodiment, when the passenger is facing in some other direction other than the travelling direction, the reduction rate is lowered as compared to the case in which the passenger is facing in the travelling direction and THEN the event data is stored. As a result, in the first embodiment, even in a situation in which it is difficult for the microphone 18 to collect the voice of the passenger because the passenger is facing in some other direction other than the travelling direction, the voice-command-based storage of event data can be performed in an appropriate manner.

### Second Embodiment

Given below is the description of a second embodiment. The second embodiment is different from the first embodiment in the way that, when a plurality of passengers is present in the vehicle, the voice recognition rate for voice commands is varied based on the direction in which the passengers are facing.

### Recording Device

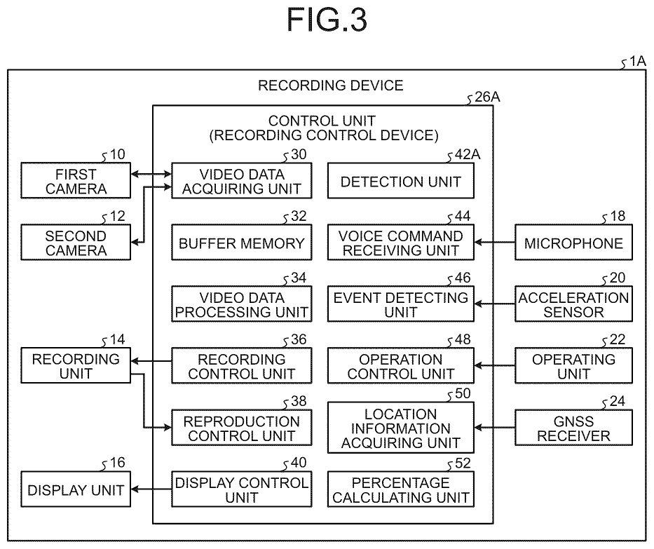

Explained below with reference to FIG. 3 is an exemplary configuration of a recording device according to the second embodiment. FIG. 3 is a block diagram illustrating an exemplary configuration of the recording device according to the second embodiment.

As illustrated in FIG. 3, a recording device 1A differs from the recording device 1, which is illustrated in FIG. 1, in such a way that a control unit 26A includes a percentage calculating unit 52.

When a plurality of passengers is present in the vehicle, a detection unit 42A detects the direction in which each passenger is facing. Thus, regarding each of a plurality of passengers, the detection unit 42A determines whether that passenger is facing in the travelling direction or is facing in some other direction other than the travelling direction. From among a plurality of passengers, if the percentage of passengers facing in some other direction other than the travelling direction is equal to or greater than a predetermined percentage, then the detection unit 42A determines that that the passengers in the vehicle are facing in some other direction other than the travelling direction of the vehicle.

The percentage calculating unit 52 calculates the percentage of the passengers who, from among a plurality of passengers, are facing in a predetermined direction. Thus, the percentage calculating unit 52 calculates the percentage of the passengers who, from among a plurality of passengers, are facing in some other direction other than the travelling direction. Herein, the percentage calculating unit 52 determines whether or not the percentage of the passengers who, from among a plurality of passengers, are facing in some other direction other than the travelling direction is equal to or greater than a predetermined percentage. For example, the predetermined percentage is equal to or greater than 50%. More particularly, when one or more passengers from among two passengers, or when two or more passengers from among three passengers, or when two or more passengers from among four passengers are facing the same direction other than the travelling direction, the percentage calculating unit 52 determines that the percentage of the passengers facing in some other direction other than the travelling direction is equal to or greater than a predetermined percentage. Meanwhile, the predetermined percentage is not limited to 50%, and can be set to some other value.

### Operations Performed by Control Unit

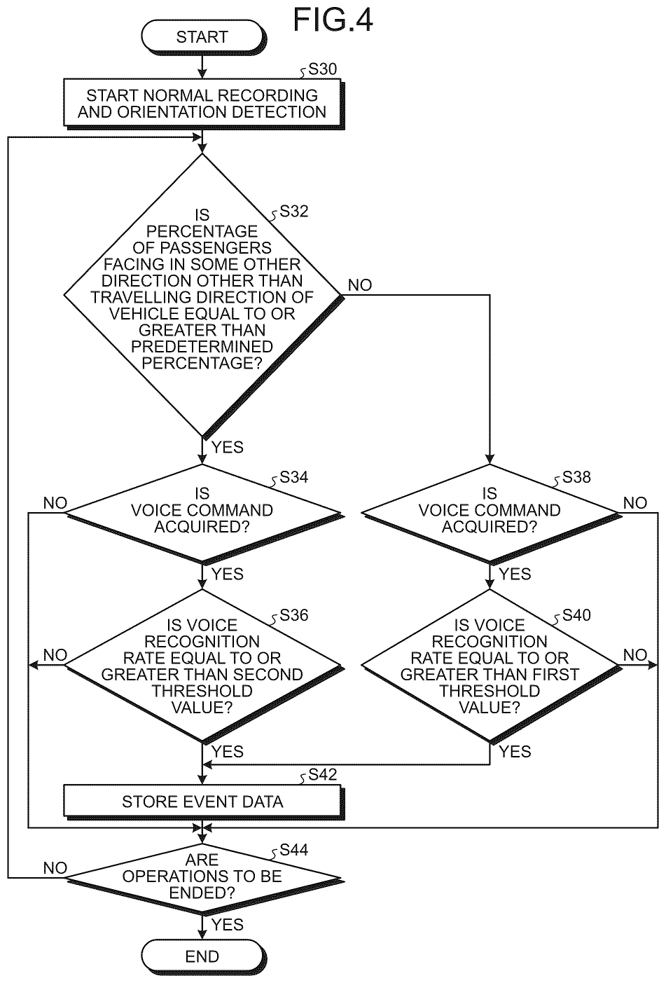

Explained below with reference to FIG. 4 is a flow of the operations that are performed by the control unit according to the second embodiment. FIG. 4 is a flowchart for explaining a flow of the operations that are performed by the control unit according to the second embodiment.

The control unit 26A starts normal recording and orientation detection (Step S30). The operation for normal recording is identical to the operation performed at Step S10 illustrated in FIG. 2. Hence, that explanation is not given again. The detection unit 42A detects the orientation of the face of each of a plurality of passengers present in the vehicle. Then, the system control proceeds to Step S22.

The detection unit 42A determines whether or not the percentage of the passengers facing in some other direction other than the travelling direction is equal to or greater than a predetermined percentage (Step S32). More particularly, based on the detection result acquired by the detection unit 42A, the percentage calculating unit 52 determines whether or not the percentage of the passengers facing in some other direction other than the travelling direction is equal to or greater than a predetermined percentage. If, from among a plurality of passengers, the percentage of the passengers facing in some other direction other than the travelling direction is equal to or greater than a predetermined percentage, then the detection unit 42A determines that the passengers in the vehicle are facing in some other direction other than the travelling direction. When it is determined that the percentage of the passengers facing in some other direction other than the travelling direction is equal to or greater than a predetermined percentage (Yes at Step S32), then the system control proceeds to Step S34. On the other hand, if it is not determined that the percentage of the passengers facing in some other direction other than the travelling direction is equal to or greater than a predetermined percentage (No at Step S32), then the system control proceeds to Step S38.

The operations performed from Step S34 to Step S44 are identical to the operations performed from Step S14 to Step S24, respectively, illustrated in FIG. 2. Hence, that explanation is not given again.

As explained above, in the second embodiment, from among a plurality of passengers present in the vehicle, according to the percentage of the passengers who are facing in some other direction other than the travelling direction, the voice recognition rate meant for recognizing a voice as a voice command is varied and then the event data is stored. In the second embodiment, when the percentage of the passengers who are facing in some other direction other than the travelling direction is equal to or greater than a predetermined percentage, the voice recognition rate is lowered and then the event data is stored. Hence, in the second embodiment, even in a situation in which it is difficult for the microphone 18 to collect the voices of a plurality of passengers because the passengers are facing in some other direction other than the travelling direction, the voice-command-based storage of event data can be performed in an appropriate manner.

### Third Embodiment

Given below is the description of a third embodiment. A recording device according to the third embodiment has an identical configuration to the recording device 1 illustrated in FIG. 1. Hence, that explanation is not given again.

### Operations Performed by Control Unit

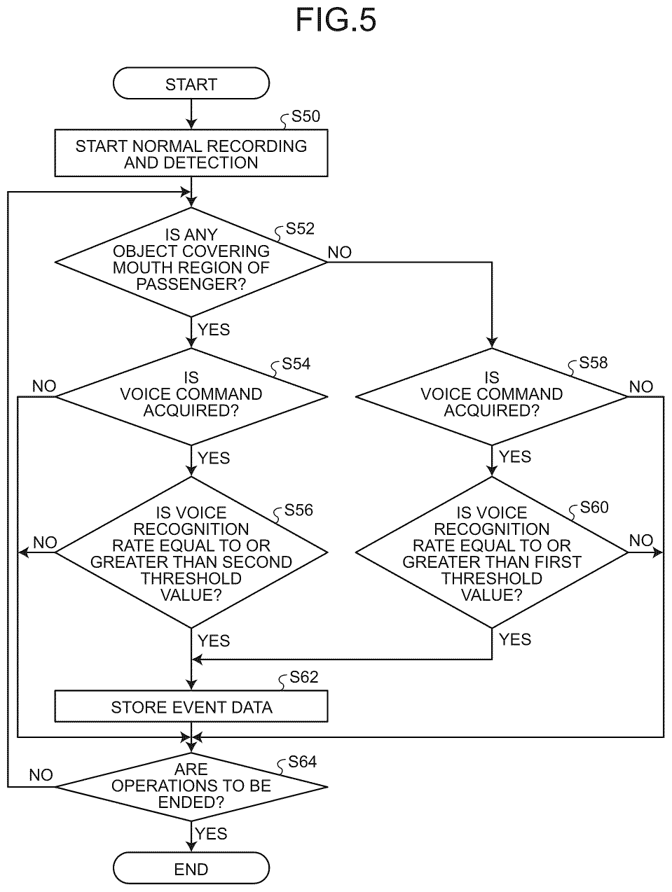

Explained below with reference to FIG. 5 is a flow of the operations that are performed by the control unit according to the third embodiment. FIG. 5 is a flowchart for explaining a flow of the operations that are performed by the control unit according to the third embodiment.

At the start of the operations, the control unit 26 starts normal recording and detection (Step S50). More particularly, the recording control unit 36 sends the video data, which is taken by the first camera 10 and the second camera 12, to the buffer memory 32; generates video files of videos each of which covers a predetermined period of time such as 60 seconds; and records the video files in the recording unit 14. Herein, the detection unit 42 starts the detection of an object meant for covering the mouth region of the passenger in the vehicle. Then, the system control proceeds to Step S52.

The detection unit 42 determines whether or not any object is covering the mouth region of the passenger (Step S52). More particularly, for example, when a predetermined area or more of the face region of the passenger is covered by an object, the detection unit 42 determines that there is an object covering the mouth region of the passenger. If it is determined that there is an object covering the mouth region of the passenger (Yes at Step S52), then the system control proceeds to Step S54. On the other hand, if it is not determined that there is an object covering the mouth region of the passenger (No at Step S52), then the system control proceeds to Step S58.

The operations performed from Step S54 to Step S64 are identical to the operations performed from Step S14 to Step S24, respectively, illustrated in FIG. 2. Hence, that explanation is not given again.

As explained above, in the third embodiment, depending on whether or not the mouth region of the passenger in the vehicle is covered by an object, the voice recognition rate meant for recognizing a voice as a voice command is varied and then the event data is stored. In the third embodiment, when the mouth region of the passenger is covered by an object, the voice recognition rate is lowered as compared to the case in which the mouth region is not covered by any object, and then the event data is stored. Thus, in the third embodiment, even in a situation in which it is difficult for the microphone 18 to collect the voice of the passenger because the mouth region of the passenger is covered by an object, the voice-command-based storage of event data can be performed in an appropriate manner.

### Fourth Embodiment

Given below is the description of a fourth embodiment. A recording device according to the fourth embodiment has an identical configuration to the recording device 1 illustrated in FIG. 1. Hence, that explanation is not given again.

### Operations Performed by Control Unit

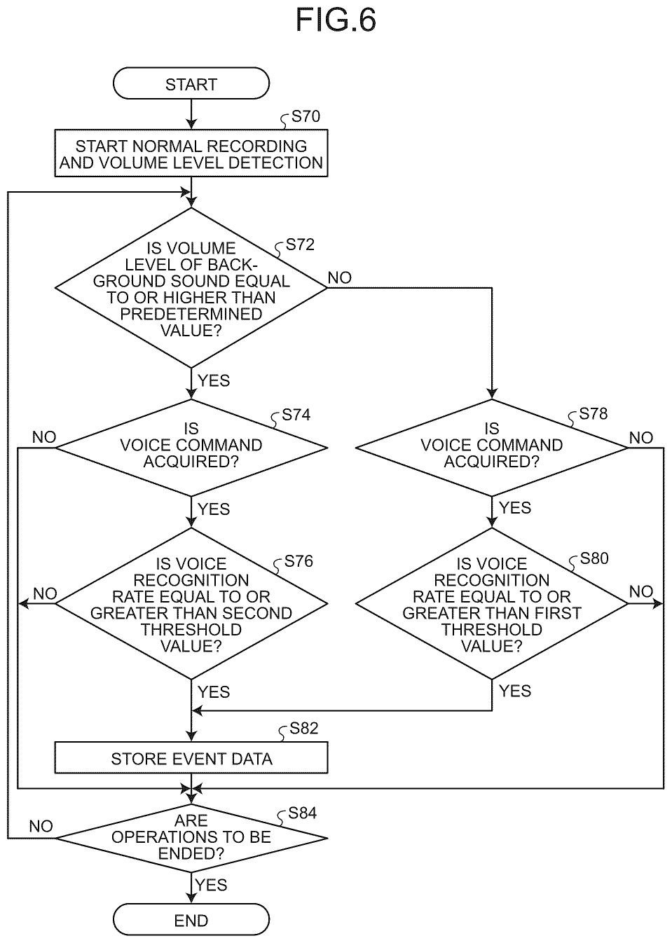

Explained below with reference to FIG. 6 is a flow of the operations that are performed by the control unit according to the fourth embodiment. FIG. 6 is a flowchart for explaining a flow of the operations that are performed by the control unit according to the fourth embodiment.

At the start of the operations, the control unit 26 starts normal recording and volume level detection (Step S70). More particularly, the recording control unit 36 sends the video data, which is taken by the first camera 10 and the second camera 12, to the buffer memory 32; generates video files of videos each of which covers a predetermined period of time such as 60 seconds; and records the video files in the recording unit 14. Herein, the detection unit 42 starts the detection of the volume level of the background sound. Then, the system control proceeds to Step S72.

The detection unit 42 determines whether or not the volume level of the background sound is equal to or greater than a predetermined value (Step S72). If it is determined that the volume level of the background sound is equal to or greater than a predetermined value (Yes at Step S72), then the system control proceeds to Step S74. On the other hand, if it is not determined that the volume level of the background sound is equal to or greater than a predetermined value (No at Step S72), then the system control proceeds to Step S78.

The operations performed from Step S74 to Step S84 are identical to the operations performed from Step S14 to Step S24, respectively, illustrated in FIG. 2. Hence, that explanation is not given again.

As explained above, in the fourth embodiment, the voice recognition rate meant for recognizing a voice as a voice command is varied depending on whether or not the volume level of the background sound is equal to or greater than a predetermined value; and then the event data is stored. In the fourth embodiment, when the volume level of the background sound is equal to or greater than a predetermined value, the voice recognition rate is lowered as compared to the case in which the volume level of the background sound is not equal to or greater than the predetermined value, and then the event data is stored. Thus, according to the fourth embodiment, even in a situation in which it is difficult for the microphone 18 to collect the voice of the passenger because the volume level of the background sound is equal to or greater than a predetermined value, the voice-command-based storage of event data can be performed in an appropriate manner.

### Fifth Embodiment

Given below is the description of a fifth embodiment. A recording device according to the fifth embodiment has an identical configuration to the recording device 1 illustrated in FIG. 1. Hence, that explanation is not given again.

### Operations Performed by Control Unit

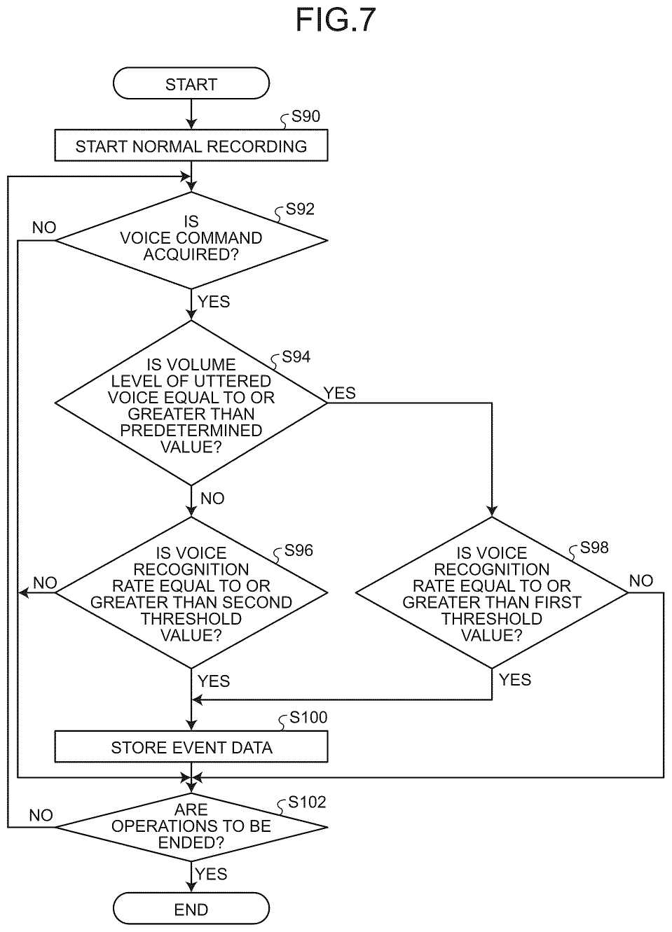

Explained below with reference to FIG. 7 is a flow of the operations that are performed by the control unit according to the fifth embodiment. FIG. 7 is a flowchart for explaining a flow of the operations that are performed by the control unit according to the fifth embodiment.

At the start of the operations, the control unit 26 starts normal recording (Step S90). The operation of normal recording is identical to the operation performed at Step S70 illustrated in FIG. 6. Hence, that explanation is not given again. Then, the system control proceeds to Step S92.

The operation performed at Step S92 is identical to the operation performed at Step S14 illustrated in FIG. 2. Hence, that explanation is not given again.

If the determination performed at Step S92 indicates an affirmative result, then the detection unit 42 determines whether or not the volume level of the uttered voice of a voice command is equal to or greater than a predetermined value (Step S94). If it is determined that that volume level of the uttered voice of a voice command is not equal to or greater than a predetermined value (No at Step S94), then the system control proceeds to Step S96. On the other hand, if it is determined that the volume level of the uttered voice of a voice command is equal to or greater than a predetermined value (Yes at Step S94), then the system control proceeds to Step S98.

The operation performed at Step S96 is identical to the operation performed at Step S16 illustrated in FIG. 2. Hence, that explanation is not given again. Moreover, the operations performed from Step S98 to Step S102 are identical to the operations performed Step S20 to Step S24 illustrated in FIG. 2. Hence, that explanation is not given again.

As explained above, in the fifth embodiment, the voice recognition rate meant for recognizing a voice as a voice command is varied depending on whether or not the volume level of the uttered voice of a voice command is equal to or greater than a predetermined value, and then the event data is stored. In the fifth embodiment, when the volume level of the uttered voice of a voice command is smaller than a predetermined value, the voice recognition rate is lowered as compared to the case in which the volume level of the uttered voice of a voice command is equal to or greater than the predetermined value, and then the event data is stored. As a result, even in a situation in which it is difficult for the microphone 18 to collect the voice of the passenger because the volume level of the uttered voice of a voice command is smaller than a predetermined value, the voice-command-based storage of event data can be performed in an appropriate manner.

### Sixth Embodiment

Given below is the description of a sixth embodiment. A recording device according to the sixth embodiment has an identical configuration to the recording device 1 illustrated in FIG. 1. Hence, that explanation is not given again.

### Operations Performed by Control Unit

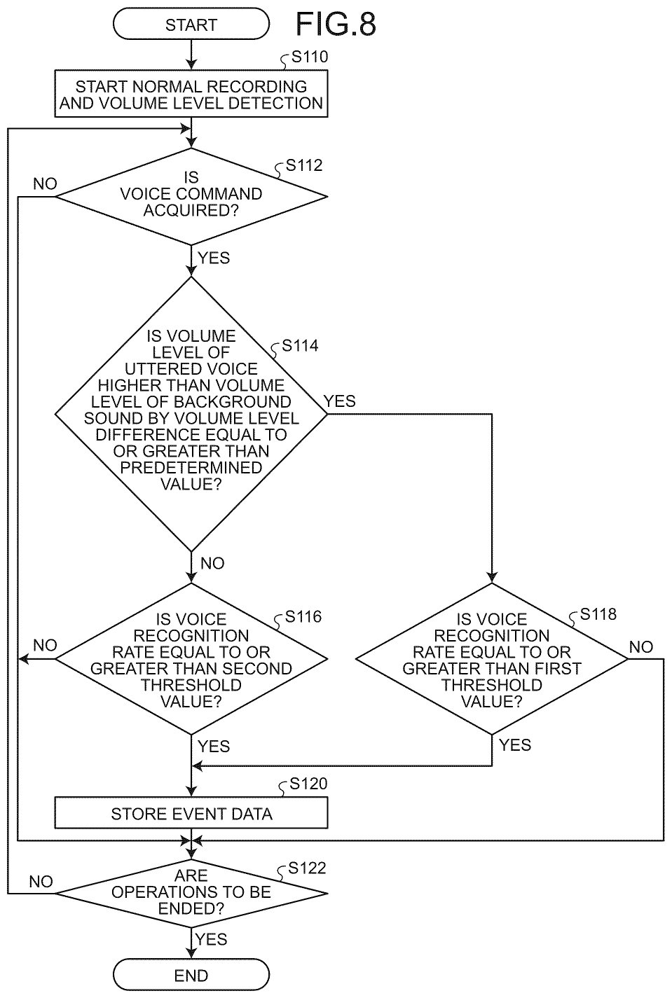

Explained below with reference to FIG. 8 is a flow of the operations that are performed by the control unit according to the sixth embodiment. FIG. 8 is a flowchart for explaining a flow of the operations that are performed by the control unit according to the sixth embodiment.

The operations performed at Step S110 and Step S112 are identical to the operations performed at Step S70 and Step S74, respectively, illustrated in FIG. 6.

If the determination performed at Step S112 indicates an affirmative result, then the detection unit 42 determines whether or not the volume level of the uttered voice is higher than the volume level of the background sound by a volume level difference equal to or greater than a predetermined value (Step S114). If it is not determined that the volume level of the uttered voice is higher than the volume level of the background sound by a volume level difference equal to or greater than a predetermined value, that is, if the volume level difference between the volume level of the uttered voice and the volume level of the background sound is lower than a predetermined value or if the volume level of the background sound is higher by a volume level difference equal to or greater than a predetermined value (No at Step S114); then the system control proceeds to Step S116. On the other hand, if it is determined that the volume level of the uttered voice is higher than the volume level of the background sound by a volume level difference equal to or greater than a predetermined value (Yes at Step S114), then the system control proceeds to Step S118.

The operation performed at Step S116 is identical to the operation performed at Step S16 illustrated in FIG. 2. Hence, that explanation is not given again. Moreover, the operations performed from Step S118 to Step S122 are identical to the operations performed from Step S20 to Step S24, respectively, illustrated in FIG. 2. Hence, that explanation is not given again.

As explained above, in the sixth embodiment, the voice recognition rate meant for recognizing a voice as a voice command is varied depending on whether or not the volume level of the uttered voice is higher than the volume level of the background sound by a volume level difference equal to or greater than a predetermined value; and then the event data is stored. In the sixth embodiment, when the volume level of the uttered voice is higher than the volume level of the background sound by a volume level difference smaller than a predetermined value, the voice recognition rate is lowered as compared to the case in which the volume level of the uttered voice is higher than the volume level of the background sound by a volume level difference equal to or greater than a predetermined value; and then the event data is stored. As a result, according to the sixth embodiment, even in a situation in which it is difficult for the microphone 18 to collect the voice of the passenger because the volume level of the uttered voice is higher than the volume level of the background sound by a volume level difference smaller than a predetermined value, the voice-command-based storage of event data can be performed in an appropriate manner.

### Seventh Embodiment

### Recording Device

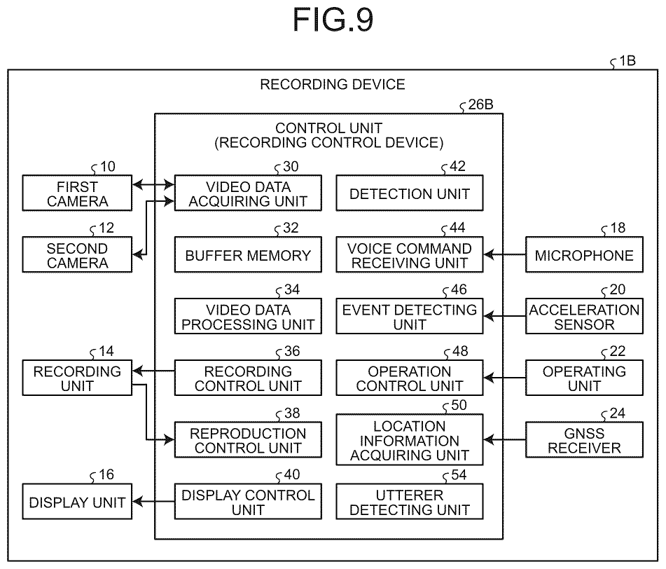

Explained below with reference to FIG. 9 is an exemplary configuration of a recording device according to a seventh embodiment. FIG. 9 is a block diagram illustrating an exemplary configuration of the recording device according to the seventh embodiment.

As illustrated in FIG. 9, a recording device 1B differs from the recording device 1, which is illustrated in FIG. 1, in such a way that a control unit 26B includes an utterer detecting unit 54.

The utterer detecting unit 54 detects the face region of a person from the second video data acquired by the video data acquiring unit 30, and detects the lip movement of the lip region captured in the detected face region. As far as the detection method for detecting the lip movement is concerned, it is possible to implement a known method without any particular restriction.

### Operations Performed by Control Unit

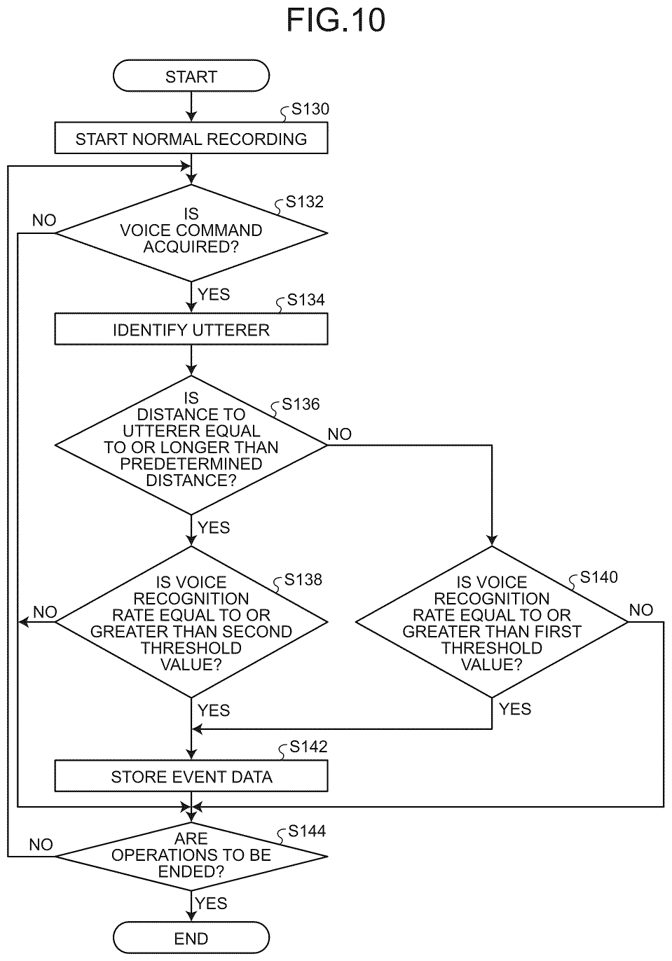

Explained below with reference to FIG. 10 is a flow of the operations that are performed by a control unit according to the seventh embodiment. FIG. 10 is a flowchart for explaining a flow of the operations that are performed by the control unit according to the seventh embodiment.

The operations performed at Step S130 and Step S132 are identical to the operations performed at Step S90 and Step S92, respectively, illustrated in FIG. 7. Hence, that explanation is not given again.

The detection unit 42 identifies the utterer of a voice command (Step S134). More particularly, the detection unit 42 determines, as the utterer of a voice command, that person for whom the voice command acquired by the voice command receiving unit 44 matches with the lip movement captured in the face region of the person detected by the utterer detecting unit 54. Then, the system control proceeds to Step S136.

The detection unit 42 determines whether or not the distance from the microphone 18 to the utterer of the voice command is equal to or longer than a predetermined distance (Step S136). If it is determined that the distance from the microphone 18 to the utterer of the voice command is equal to or longer than a predetermined distance (Yes at Step S136), then the system control proceeds to Step S138. On the other hand, if it is not determined that the distance from the microphone 18 to the utterer of the voice command is equal to or longer than a predetermined distance (No at Step S136), then the system control proceeds to Step S140.

The operation performed at Step S138 is identical to the operation performed at Step S16 illustrated in FIG. 2. Hence, that explanation is not given again. Moreover, the operations performed from Step S140 to Step S144 are identical to the operations performed from Step S20 to Step S24, respectively, illustrated in FIG. 2.

As explained above, in the seventh embodiment, the voice recognition rate meant for recognizing a voice as a voice command is varied depending on whether or not the distance from the microphone 18 to the utterer of a voice command is equal to or longer than a predetermined distance; and then the event data is stored. In the seventh embodiment, if the distance from the microphone 18 to the utterer of a voice command is equal to or longer than a predetermined distance, then the voice recognition rate is lowered as compared to the case in which the distance is shorter than the predetermined distance, and then the event data is stored. As a result, in the seventh embodiment, even in a situation in which it is difficult for the microphone 18 to collect the voice of the utterer because the distance from the microphone 18 to the utterer of a voice command is equal to or longer than a predetermined distance, the voice-command-based storage of event data can be performed in an appropriate manner.

### Eighth Embodiment

Given below is the description about an eighth embodiment. The eighth embodiment can be implemented in a general-purpose device which is operatable using voice commands. Examples of such a device include a household appliance such as a smart speaker or a television receiver; an information device such as a smartphone, a tablet terminal, or a PC; and a navigation system or an infotainment system used in vehicles.

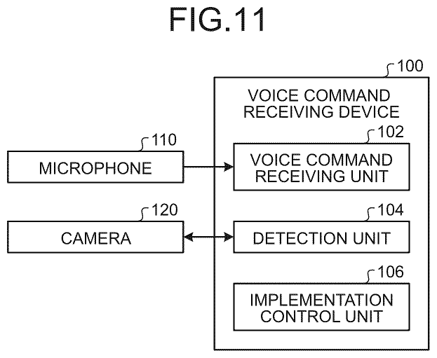

Explained below with reference to FIG. 11 is an exemplary configuration of a voice command receiving device according to the eighth embodiment. FIG. 11 is a block diagram illustrating an exemplary configuration of the voice command receiving device according to the eighth embodiment.

As illustrated in FIG. 11, a voice command receiving device 100 includes a voice command receiving unit 102, a detection unit 104, and an implementation control unit 106. The voice command receiving device 100 is configured using, for example, an information processing device such as a CPU or an MPU, and a memory device such as a RAM or a ROM. The voice command receiving device 100 executes a computer program according to the application concerned. Meanwhile, the voice command receiving device 100 can alternatively be implemented using an integrated circuit such as an ASIC or an FPGA. Still alternatively, the voice command receiving device 100 can be implemented by combining hardware and software.

A microphone 110 collects the voice uttered by an utterer. Then, the microphone 110 outputs voice information related to the collected voice to the voice command receiving device 100. Herein, the microphone 110 either can be configured in an integrated manner with the voice command receiving device 100 or can be configured as a separate entity.

A camera 120 takes images of the utterer. Herein, the camera 120 takes images of at least the face of the utterer. Then, the camera 120 outputs video data related to the taken video to the voice command receiving device 100. The camera 120 either can be configured in an integrated manner with the voice command receiving device 100 or can be configured as a separate entity.

The voice command receiving unit 102 receives a voice command. For example, the voice command receiving unit 102 recognizes the sounds collected by the microphone 110, and accordingly receives a voice command.

The detection unit 104 detects, in the environment in which voice commands are uttered, the conditions that lead to a situation in which a voice command is not properly recognizable. In the eighth embodiment, the detection unit 104 detects the orientation of the face of the person who uttered a voice command. For example, based on the video data captured by the camera 120, the detection unit 104 detects the orientation of the face of the person who uttered a voice command.

Moreover, the detection unit 104 detects, in the environment in which voice commands are uttered, the conditions that lead to a situation in which a voice command is not properly recognizable. In the eighth embodiment, the detection unit 104 starts the detection of an object covering the mouth region of the person who uttered a voice command. For example, based on the video data captured by the camera 120, the detection unit 104 starts the detection of an object covering the mouth region of the person who uttered a voice command.

Furthermore, the detection unit 104 detects the volume level of the background sound in the environment in which voice commands are uttered, detects the volume level of the uttered voice of the voice command, and detects the difference between the volume level of the background sound in the environment in which voice commands are uttered and the volume level of the uttered voice of the voice command. For example, based on the sounds collected by the microphone 110, the detection unit 104 detects the volume level of the background sound in the environment in which voice commands are uttered, detects the volume level of the uttered voice of the voice command, and detects the difference between the volume level of the background sound in the environment in which voice commands are uttered and the volume level of the uttered voice of the voice command.

The detection unit 104 detects, in the environment in which voice commands are uttered, the conditions that lead to a situation in which a voice command is not properly recognizable. In the eighth embodiment, the detection unit 104 detects the distance between the microphone 110 and the person who uttered a voice command. For example, based on the video data captured by the camera 120, the detection unit 104 identifies the utterer of the voice command. Thus, based on the video data captured by the camera 120, the detection unit 104 detects the distance between the microphone 110 and the identified utterer of the voice command.

When the voice command receiving unit 102 receives a voice command, the implementation control unit 106 implements functions with respect to the received voice command.

Depending on whether or not the face of the passenger as detected by the detection unit 104 is facing in the direction of the microphone 110 that is used for acquiring the uttered voice of the voice commands; the voice command receiving unit 102 varies the voice recognition rate meant for determining whether or not a voice command is acquired, and then receives a voice command. For example, when it is determined that the orientation of the face of the person is facing in the direction of the microphone 110, the voice command receiving unit 102 receives a voice command at the voice recognition rate equal to or greater than a first threshold value. On the other hand, for example, when it is determined that the orientation of the face of the person is facing in some other direction other than the direction of the microphone 110, the voice command receiving unit 102 receives a voice command at the voice recognition rate equal to or greater than a second threshold value that is lower than the first threshold value.

Moreover, depending on the presence or absence of an object covering the mouth region on the face of the person as detected by the detection unit 104, the voice command receiving unit 102 varies the voice recognition rate for voice commands and then receives a voice command. For example, when it is determined that there is no object covering the mouth region on the face of the person, the voice command receiving unit 102 receives a voice command at the voice recognition rate equal to or greater than the first threshold value. On the other hand, for example, when it is determined that there is an object covering the mouth region on the face of the person, the voice command receiving unit 102 receives a voice command at the voice recognition rate equal to or greater than the second threshold value that is smaller than the first threshold value.

Furthermore, depending on whether or not the volume level of the background sound is equal to or greater than a predetermined value, the voice command receiving unit 102 varies the voice recognition rate for voice commands and then receives a voice command. For example, when it is not determined that the volume level of the background sound is equal to or greater than the predetermined value, the voice command receiving unit 102 receives a voice command at the voice recognition rate equal to or greater than the first threshold value. On the other hand, for example, when it is determined that the volume level of the background sound is equal to or greater than the predetermined value, the voice command receiving unit 102 receives a voice command at the voice recognition rate equal to or greater than the second threshold value that is smaller than the first threshold value.

Moreover, depending on whether or not the volume level of the uttered voice of a voice command is equal to or greater than a predetermined value, the voice command receiving unit 102 varies the voice recognition rate for voice commands and then receives a voice command. For example, when it is not determined that the volume level of the uttered voice of a voice command is equal to or greater than a predetermined value, the voice command receiving unit 102 receives the voice command at the voice recognition rate equal to or greater than the first threshold value. On the other hand, when it is determined that the volume level of the uttered voice of a voice command is equal to or greater than a predetermined value, the voice command receiving unit 102 receives the voice command at the voice recognition rate equal to or greater than the second threshold value that is smaller than the first threshold value.

Furthermore, depending on whether or not the volume level of the uttered voice of a voice command is higher than the volume level of the background sound by a volume level difference equal to or greater than a predetermined value, the voice command receiving unit 102 varies the voice recognition rate for voice commands and then receives a voice command. For example, when it is determined that the volume level of the uttered voice of a voice command is higher than the volume level of the background sound by a volume level difference equal to or greater than a predetermined value, the voice command receiving unit 102 receives a voice command at the voice recognition rate equal to or greater than the first threshold value. On the other hand, for example, when it is not determined that the volume level of the uttered voice of a voice command is higher than the volume level of the background sound by a volume level difference equal to or greater than a predetermined value, the voice command receiving unit 102 receives a voice command at the voice recognition rate equal to or greater than the second threshold value that is smaller than the first threshold value.

Moreover, depending on the distance between the microphone 110 and the utterer of a voice command, the voice command receiving unit 102 varies the voice recognition rate for voice commands and then receives the voice command. For example, when it is determined that the distance between the microphone 110 and the utterer of the voice command is equal to or longer than a predetermined distance, the voice command receiving unit 102 receives the voice command at the voice recognition rate equal to or greater than the first threshold value. On the other hand, for example, when it is determined that the distance between the microphone 110 and the utterer of the voice command is shorter than a predetermined distance, the voice command receiving unit 102 receives the voice command at the voice recognition rate equal to or greater than the second threshold value that is smaller than the first threshold value.

Regarding a voice command having high urgency or high immediacy, the voice command receiving unit 102 receives the voice command at the voice recognition rate equal to or greater than the second threshold value. In the eighth embodiment, a voice command having high urgency or high immediacy implies such a voice command for which it is not desirable to have any delay from the point of time of operation in regard to the start of implementation or the end of implementation of a function such as an emergency call, an emergency communication, an instruction to start the recording of broadcast content, or an instruction to stop a function posing high risk due to continuation. Alternatively, a voice command having high urgency or high immediacy implies a voice command issued with respect to such a function which would exert an adverse effect or cause a risk in case there is a delay.

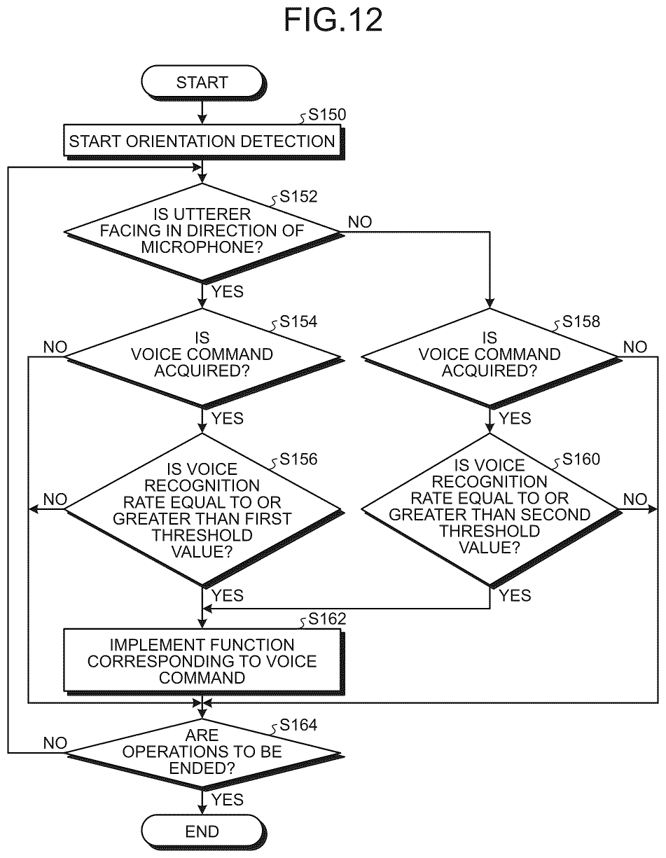

Operations performed by voice command receiving device Explained below with reference to FIG. 12 is a flow of the operations that are performed by the voice command receiving device according to the eighth embodiment. FIG. 12 is a flowchart for explaining a flow of the operations that are performed by the voice command receiving device according to the eighth embodiment.

The detection unit 104 starts orientation detection (Step S150). More particularly, the detection unit 104 starts the detection of the orientation of the face of the utterer. Then, the system control proceeds to Step S152.

The detection unit 104 determines whether or not the utterer is facing in the direction of the microphone 110 (Step S152). More particularly, the detection unit 42 determines whether or not the utterer is facing in the direction of the microphone 110 for a predetermined period of time or more. If the utterer is facing in the direction of the microphone 110 for a predetermined period of time or more, then the detection unit 42 determines that the utterer is facing in the direction of the microphone 110. Herein, for example, the predetermined period of time is equal to or longer than two seconds. However, that is not the only possible case. If it is determined that the utterer is facing in the direction of the microphone 110 (Yes at Step S152), then the system control proceeds to Step S154. On the other hand, if it is not determined that the utterer is facing in the direction of the microphone 110 (No at Step S152), then the system control proceeds to Step S158.

When the determination performed at Step S152 indicates an affirmative result, the voice command receiving unit 102 determines whether or not the microphone 110 has acquired a voice command from the utterer (Step S154). If it is determined that a voice command is acquired (Yes at Step S154), then the system control proceeds to Step S156. On the other hand, if it is not determined that a voice command is acquired (No at Step S154), then the system control proceeds to Step S164.

When the determination performed at Step S154 indicates an affirmative result, the voice command receiving unit 102 determines whether or not the voice recognition rate of the acquired voice command is equal to or greater than the first threshold value (Step S156). If it is determined that the voice recognition rate of the acquired voice command is equal to or greater than the first threshold value (Yes at Step S156), then the system control proceeds to Step S162. On the other hand, if it is not determined that the voice recognition rate of the acquired voice command is equal to or greater than the first threshold value (No at Step S156), then the system control proceeds to Step S164.

When the determination performed at Step S152 indicates a negative result, the voice command receiving unit 102 determines whether or not the microphone 110 has acquired a voice command from the utterer (Step S158). If it is determined that a voice command is acquired (Yes at Step S158), then the system control proceeds to Step S160. On the other hand, if it is not determined that a voice command is acquired (No at Step S158), then the system control proceeds to Step S164.

When the determination performed at Step S158 indicates an affirmative result, the voice command receiving unit 102 determines whether or not the voice recognition rate for the acquired voice command is equal to or greater than the second threshold value (Step S160). If it is determined that the voice recognition rate for the acquired voice command is equal to or greater than the second threshold value (Yes at Step S160), then the system control proceeds to Step S162. On the other hand, if it is not determined that the voice recognition rate for the acquired voice command is equal to or greater than the second threshold value (No at Step S160), then the system control proceeds to Step S164.

At Steps S154 and S158, in addition to determining whether or not a voice command is acquired, it can also be determined whether or not the acquired voice command has high urgency or high immediacy.

When the determination performed at Step S156 or Step S160 indicates an affirmative result, the implementation control unit 106 implements the function corresponding to the voice command (Step S162). Then, the system control proceeds to Step S164.

On the other hand, when the determination at any step from Step S154 to Step S160 indicates a negative result or after the operation at Step S162 is performed, the voice command receiving device 100 determines whether or not to end the operations (Step S164). More particularly, when an operation for switching off the power source is received or when an operation indicating the end of the operations is received, the voice command receiving device 100 determines to end the operations. When it is determined to end the operations (Yes at Step S164), the operations illustrated in FIG. 12 are ended. On the other hand, if it is not determined to end the operations (No at Step S164), then the system control returns to Step S152.

As explained above, in the eighth embodiment, the voice recognition rate meant for recognizing a voice as a voice command is varied depending on whether or not the utterer is facing in the direction of the microphone, and then the function corresponding to the voice command is implemented. In the eighth embodiment, when the utterer is facing in some other direction other than the direction of the microphone, the voice recognition rate is lowered as compared to the case in which the utterer is facing in the direction of the microphone; and then the function corresponding to the voice command is implemented. As a result, according to the eighth embodiment, even in a situation in which it is difficult for the microphone to collect the voice of the utterer because the utterer is facing in some other direction other than the direction of the microphone, the function corresponding to the voice commands can be implemented in an appropriate manner.

### Ninth Embodiment

Given below is the description of a ninth embodiment. A voice command receiving device according to the ninth embodiment has an identical configuration to the voice command receiving device 100 illustrated in FIG. 11. Hence, that explanation is not given again.

### Operations Performed by Voice Command Receiving Device

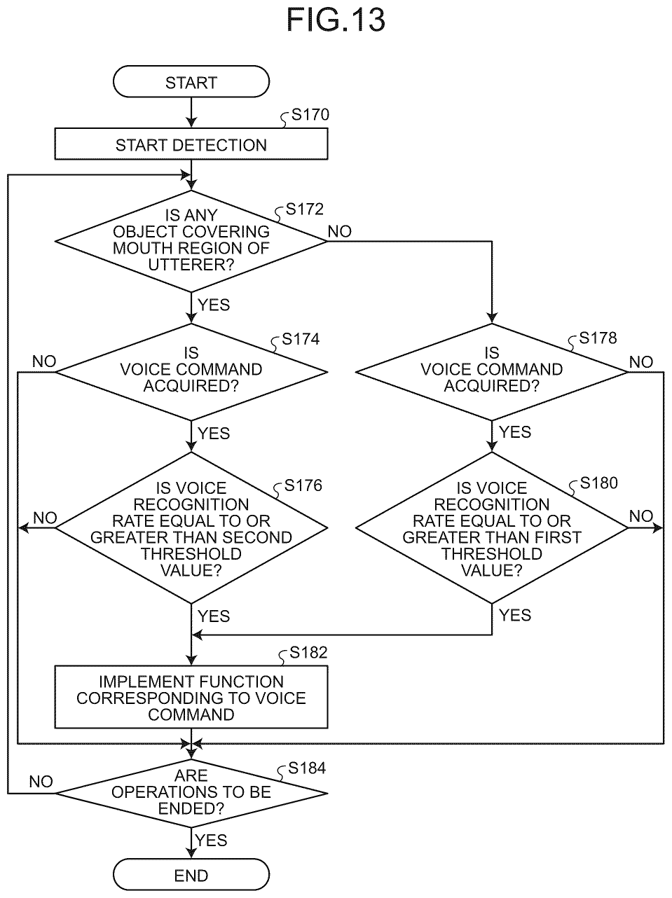

Explained below with reference to FIG. 13 is a flow of the operations that are performed by the voice command receiving device according to the ninth embodiment. FIG. 13 is a flowchart for explaining a flow of the operations that are performed by the voice command receiving device according to the ninth embodiment.

The detection unit 104 starts detection (Step S170). More particularly, the detection unit 104 starts the detection of an object covering the mouth region of the utterer. Then, the system control proceeds to Step S172.

The detection unit 104 determines whether or not there is any object covering the mouth region of the face of the utterer (Step S172). More particularly, for example, when a predetermined area or more of the face region of the utterer is covered by an object, the detection unit 104 determines that there is an object covering the mouth region of the utterer. If it is determined that there is an object covering the mouth region of the utterer (Yes at Step S172), then the system control proceeds to Step S174. On the other hand, if it is not determined that there is an object covering the mouth region of the utterer (No at Step S172), then the system control proceeds to Step S178.

The operations performed at Step S174 and Step S176 are identical to the operations performed at Step S158 and Step S160, respectively, illustrated in FIG. 12. Hence, that explanation is not given again. Moreover, the operations performed at Step S178 and Step S180 are identical to the operations performed at Step S154 and Step S156, respectively, illustrated in FIG. 12. Hence, that explanation is not given again. Furthermore, the operations performed at Step S182 and Step S184 are identical to the operations performed at Step S162 and Step S164, respectively, illustrated in FIG. 12. Hence, that explanation is not given again.

As explained above, in the ninth embodiment, the voice recognition rate meant for recognizing a voice as a voice command is varied depending on whether or not the mouth region of the utterer is covered by an object, and then the function corresponding to the voice command is implemented. In the ninth embodiment, when the mouth region of the utterer is covered by an object, the voice recognition rate is lowered as compared to the case in which the mouth region is not covered by an object, and then the function corresponding to the voice command is implemented. As a result, even in a situation in which it is difficult for the microphone to collect the voice of the utterer because the mouth region of the utterer is covered by an object, the function corresponding to the voice command can be implemented in an appropriate manner.

### Tenth Embodiment

Given below is the description of a tenth embodiment. A voice command receiving device according to the tenth embodiment has an identical configuration to the voice command receiving device 100 illustrated in FIG. 11. Hence, that explanation is not given again.

### Operations Performed by Voice Command Receiving Device

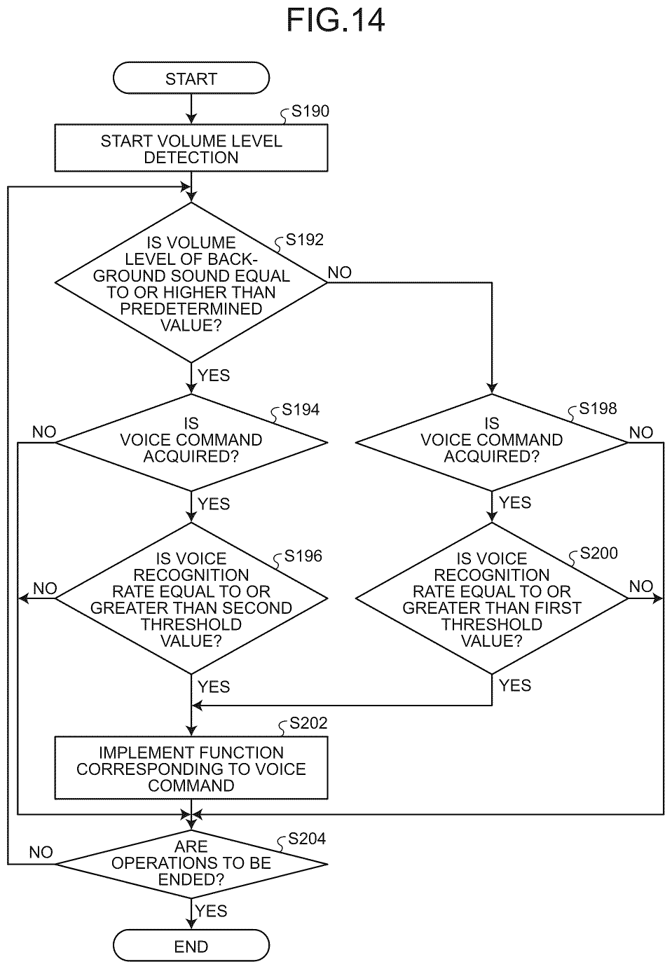

Explained below with reference to FIG. 14 is a flow of the operations that are performed by the voice command receiving device according to the tenth embodiment. FIG. 14 is a flowchart for explaining a flow of the operations that are performed by the voice command receiving device according to the tenth embodiment.

The detection unit 104 starts volume level detection (Step S190). More particularly, the detection unit 104 starts the detection of the volume level of the background sound. Then, the system control proceeds to Step S192.

The detection unit 104 determines whether or not the volume level of the background sound is equal to or greater than a predetermined value (Step S192). If it is determined that the volume level of the background sound is equal to or greater than a predetermined value (Yes at Step S192), then the system control proceeds to Step S194. On the other hand, if it is not determined that the volume level of the background sound is equal to or greater than a predetermined value (No at Step S192), then the system control proceeds to Step S198.

The operations performed at Step S194 and Step S196 are identical to the operations performed at Step S158 and Step S160, respectively, illustrated in FIG. 12. Hence, that explanation is not given again. Moreover, the operations performed at Step S198 and Step S200 are identical to the operations performed at Step S154 and Step S156, respectively, illustrated in FIG. 12. Hence, that explanation is not given again. Furthermore, the operations performed at Step S202 and Step S204 are identical to the operations performed at Step S162 and Step S164, respectively, illustrated in FIG. 12. Hence, that explanation is not given again.

As explained above, according to the tenth embodiment, the voice recognition rate meant for recognizing a voice as a voice command is varied depending on whether or not the volume level of the background sound is equal to or greater than a predetermined value; and then the function corresponding to the voice command is implemented. In the tenth embodiment, when the volume level of the background sound is equal to or greater than a predetermined value, the voice recognition rate is lowered as compared to the case in which the volume level of the background sound is not equal to or greater than the predetermined value, and then the function corresponding to the voice command is implemented. Thus, according to the tenth embodiment, even in a situation in which it is difficult for the microphone to collect the voice of the utterer because the volume level of the background sound is equal to or greater than a predetermined value, the function corresponding to the voice commands can be implemented in an appropriate manner.

### Eleventh Embodiment

Given below is the description of an eleventh embodiment. A voice command receiving device according to the eleventh embodiment has an identical configuration to the voice command receiving device 100 illustrated in FIG. 11. Hence, that explanation is not given again.

### Operations Performed by Voice Command Receiving Device

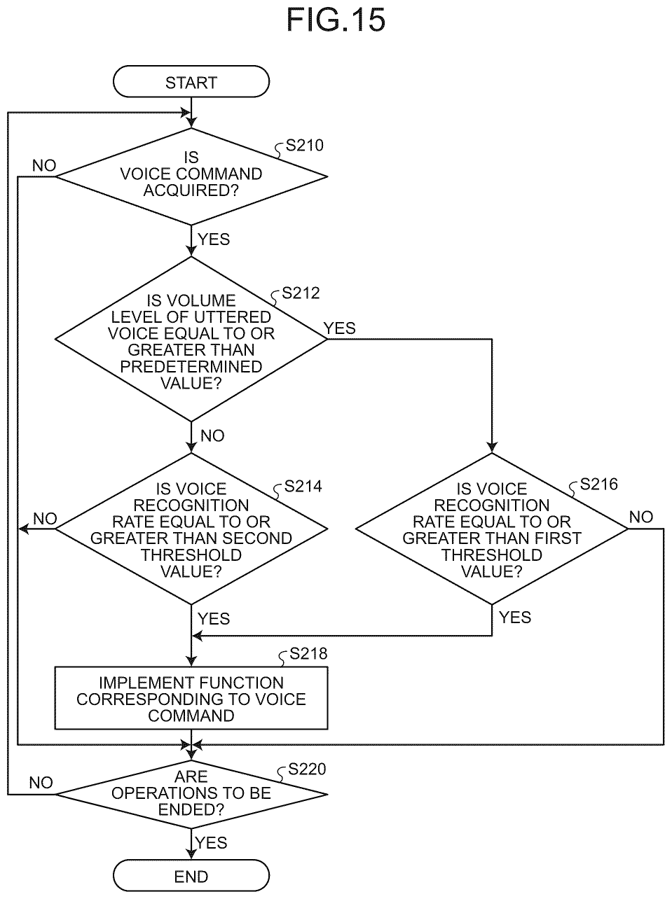

Explained below with reference to FIG. 15 is a flow of the operations that are performed by the voice command receiving device according to the eleventh embodiment. FIG. 15 is a flowchart for explaining a flow of the operations that are performed by the voice command receiving device according to the eleventh embodiment.

The operation performed at Step S210 is identical to the operation performed at Step S154 illustrated in FIG. 12. Hence, that explanation is not given again.

When the determination performed at Step S210 indicates an affirmative result, the detection unit 104 determines whether or not the volume level of the uttered voice of the utterer is equal to or greater than a predetermined value (Step S212). If it is not determined that the volume level of the uttered voice of the utterer is equal to or greater than a predetermined value (No at Step S212), then the system control proceeds to Step S214. On the other hand, if it is determined that the volume level of the uttered voice of the utterer is equal to or greater than a predetermined value (Yes at Step S212), then the system control proceeds to Step S216.

The operations performed at Step S214 and Step S216 are identical to the operations performed at Step S160 and Step S156, respectively. Hence, that explanation is not given again. Moreover, the operations performed at Step S218 and Step S220 are identical to the operations performed at Step S162 and Step S164, respectively, illustrated in FIG. 12. Hence, that explanation is not given again.

As explained above, according to the eleventh embodiment, the voice recognition rate meant for recognizing a voice as a voice command is varied depending on whether or not the volume level of the uttered voice is equal to or greater than a predetermined value, and then the function corresponding to the voice command is implemented. In the eleventh embodiment, when the volume level of the uttered voice is smaller than a predetermined value, the voice recognition rate is lowered as compared to the case in which the volume level of the uttered voice is equal to or greater than the predetermined value, and then the function corresponding to the voice command is implemented. As a result, according to the eleventh embodiment, even in a situation in which it is difficult for the microphone to collect the voice of the utterer because the volume level of the uttered voice is smaller than a predetermined value, the function corresponding to the voice command can be implemented in an appropriate manner.

### Twelfth Embodiment

Given below is the description of a twelfth embodiment. A voice command receiving device according to the twelfth embodiment has an identical configuration to the voice command receiving device 100 illustrated in FIG. 11. Hence, that explanation is not given again.

### Operations Performed by Voice Command Receiving Device

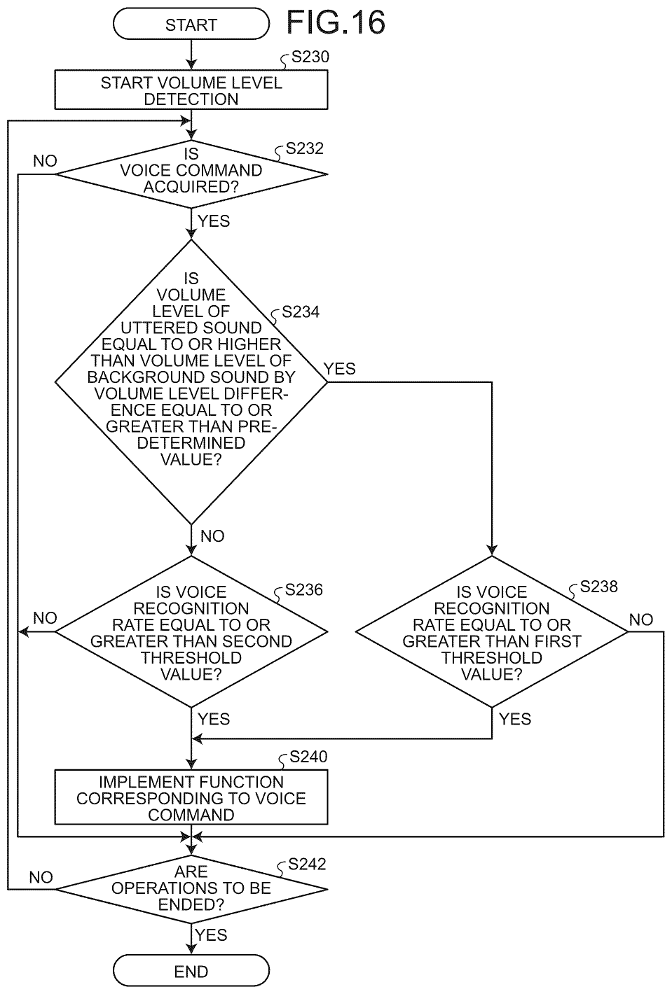

Explained below with reference to FIG. 16 is a flow of the operations that are performed by the voice command receiving device according to the twelfth embodiment. FIG. 16 is a flowchart for explaining a flow of the operations that are performed by the voice command receiving device according to the twelfth embodiment.

The operation performed at Step S230 is identical to the operation performed at Step S190 illustrated in FIG. 14. Hence, that explanation is not given again. Moreover, the operation performed at Step S232 is identical to the operation performed at Step S154 illustrated in FIG. 12. Hence, that explanation is not given again.

When the determination performed at Step S232 indicates an affirmative result, the detection unit 104 determines whether or not the volume level of the uttered voice of the utterer is higher than the volume level of the background sound by a volume level difference equal to or greater than a predetermined value (Step S234). If it is not determined that the volume level of the uttered voice of the utterer is higher than the volume level of the background sound by a volume level difference equal to or greater than a predetermined value, that is, if the volume difference between the volume level of the uttered voice and the volume level of the background sound is lower than a predetermined value or if the volume level of the background sound is higher by a volume level difference equal to or greater than a predetermined value (No at Step S234); then the system control proceeds to Step S236. On the other hand, if it is determined that the volume level of the uttered voice of the utterer is higher than the volume level of the background sound by a volume level difference equal to or greater than a predetermined value (Yes at Step S234), then the system control proceeds to Step S238.

The operations performed at Step S236 and Step S238 are identical to the operations performed at Step S160 and Step S156, respectively. Hence, that explanation is not given again. Moreover, the operations performed at Step S240 and Step S242 are identical to the operations performed at Step S162 and Step S164, respectively, illustrated in FIG. 12. Hence, that explanation is not given again.

As explained above, in the twelfth embodiment, the voice recognition rate meant for recognizing a voice as a voice command is varied depending on whether or not the volume level of the uttered voice is higher than the volume level of the background sound by a volume level difference equal to or greater than a predetermined value, and then the function corresponding to the voice command is implemented. In the twelfth embodiment, when the volume level of the uttered voice is higher than the volume level of the background sound by a volume level difference smaller than a predetermined value, the voice recognition rate is lowered as compared to the case in which the volume level of the uttered voice is higher than the volume level of the background sound by a volume level difference equal to or greater than a predetermined value; and then the function corresponding to the voice command is implemented. As a result, according to the twelfth embodiment, even in a situation in which it is difficult for the microphone to collect the voice of the utterer because the volume level of the uttered voice is higher than the volume level of the background sound by a volume level difference smaller than a predetermined value, the function corresponding to the voice command can be implemented in an appropriate manner.

### Thirteenth Embodiment

Given below is the description of a thirteenth embodiment. A voice command receiving device according to the thirteenth embodiment has an identical configuration to the voice command receiving device 100 illustrated in FIG. 11. Hence, that explanation is not given again.

### Operations Performed by Voice Command Receiving Device

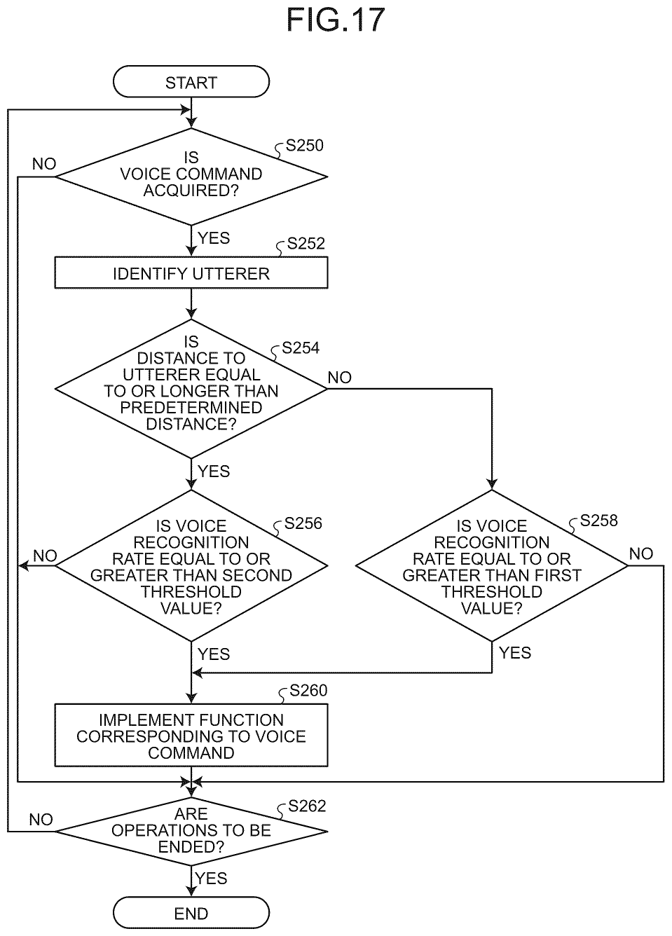

Explained below with reference to FIG. 17 is a flow of the operations that are performed by the voice command receiving device according to the thirteenth embodiment. FIG. 17 is a flowchart for explaining a flow of the operations that are performed by the voice command receiving device according to the thirteenth embodiment.

The operation performed at Step S250 is identical to the operation performed at Step S154 illustrated in FIG. 12. Hence, that explanation is not given again.

When the determination performed at Step S250 indicates an affirmative result, the detection unit 104 identifies the utterer of the voice command (Step S252). Then, the system control proceeds to Step S254.

The detection unit 104 determines whether or not the distance from the microphone 110 to the utterer of the voice command is equal to or longer than a predetermined distance (Step S254). If it is determined that the distance from the microphone 110 to the utterer of the voice command is equal to or longer than a predetermined distance (Yes at Step S254), then the system control proceeds to Step S256. On the other hand, if it is not determined that the distance from the microphone 110 to the utterer of the voice command is equal to or longer than a predetermined distance (No at Step S254), then the system control proceeds to Step S258.

The operations performed at Step S256 and Step S258 are identical to the operations performed at Step S160 and Step S156, respectively. Hence, that explanation is not given again. Moreover, the operations performed at Step S260 and Step S262 are identical to the operations performed at Step S162 and Step S164, respectively, illustrated in FIG. 12. Hence, that explanation is not given again.

As explained above, according to the thirteenth embodiment, the voice recognition rate meant for recognizing a voice as a voice command is varied depending on whether or not the distance from the microphone 110 to the utterer of a voice command is equal to or longer than a predetermined distance; and then the function corresponding to the voice command is implemented. In the thirteenth embodiment, when the distance from the microphone 110 to the utterer of a voice command is equal to or longer than a predetermined distance, the voice recognition rate is lowered as compared to the case in which that distance is shorter than the predetermined distance, and then the function corresponding to the voice command is implemented. As a result, in the thirteenth embodiment, even in a situation in which it is difficult for the microphone 110 to collect the voice of the utterer because the distance from the microphone 110 to the utterer of a voice command is equal to or longer than a predetermined distance, the function corresponding to the voice command can be implemented in an appropriate manner.

The computer program causing the voice command receiving device according to the present disclosure to implement the voice command receiving method according to the present disclosure may be provided by being stored in a non-transitory computer-readable storage medium, or may be provided via a network such as the Internet. Examples of the computer-readable storage medium include optical discs such as a digital versatile disc (DVD) and a compact disc (CD), and other types of storage devices such as a hard disk and a semiconductor memory.

According to the application concerned, operations based on voice commands can be implemented in an appropriate manner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A voice command receiving device comprising:
a voice command receiving unit configured to receive a voice command;
a detection unit configured to, in an environment in which the voice command is uttered, detect a condition leading to a situation in which a voice command is not properly recognizable; and
an implementation control unit configured to, when the voice command receiving unit receives a voice command, implement a function with respect to the received voice command, wherein
the voice command receiving unit is configured to:
when the detection unit determines absence of a condition leading to a situation in which a voice command is not properly recognizable, receive a voice command at a voice recognition rate, which is regarding voice commands acquired by the voice command receiving unit, equal to or greater than a first threshold value; and
when the detection unit determines presence of a condition leading to a situation in which a voice command is not properly recognizable, receive a voice command at a voice recognition rate, which is regarding voice commands acquired by the voice command receiving unit, equal to or greater than a second threshold value that is smaller than the first threshold value.

2. The voice command receiving device according to claim 1, wherein
as a condition leading to a situation in which a voice command is not properly recognizable, the detection unit is configured to detect orientation of face of a person who utters the voice command, and
the voice command receiving unit is configured to:
when the detection unit determines that orientation of face of the person is toward a microphone which acquires uttered voice of the voice command, receive a voice command at a voice recognition rate, which is regarding voice commands acquired by the voice command receiving unit, equal to or greater than a first threshold value; and
when the detection unit determines that orientation of face of the person is not toward the microphone, receive a voice command at a voice recognition rate, which is regarding voice commands acquired by the voice command receiving unit, equal to or greater than a second threshold value that is smaller than the first threshold value.

3. The voice command receiving device according to claim 1, wherein
as a condition leading to a situation in which a voice command is not properly recognizable, the detection unit is configured to detect presence or absence of an object covering mouth region of a person who utters the voice command, and
the voice command receiving unit is configured to:
when the detection unit determines absence of an object covering mouth region of the person, receive a voice command at a voice recognition rate, which is regarding voice commands acquired by the voice command receiving unit, equal to or greater than a first threshold value; and
when the detection unit determines presence of an object covering mouth region of the person, receive a voice command at a voice recognition rate, which is regarding voice commands acquired by the voice command receiving unit, equal to or greater than a second threshold value that is smaller than the first threshold value.

4. The voice command receiving device according to claim 1, wherein
as a condition leading to a situation in which a voice command is not properly recognizable, the detection unit is configured to detect volume level of background sound of environment in which the voice command is received, and
the voice command receiving unit is configured to:
when volume level of the background sound is determined to be lower than a predetermined value, receive a voice command at a voice recognition rate, which is regarding voice commands acquired by the voice command receiving unit, equal to or greater than a first threshold value; and
when volume level of the background sound is determined to be equal to or higher than the predetermined value, receive a voice command at a voice recognition rate, which is regarding voice commands acquired by the voice command receiving unit, equal to or greater than a second threshold value that is smaller than the first threshold value.

5. The voice command receiving device according to claim 1, wherein
as a condition leading to a situation in which a voice command is not properly recognizable, the detection unit is configured to detect volume level of uttered voice of the voice command, and
the voice command receiving unit is configured to:
when volume level of uttered voice of the voice command is determined to be equal to or higher than a predetermined value, receive a voice command at a voice recognition rate, which is regarding voice commands acquired by the voice command receiving unit, equal to or greater than a first threshold value; and
when volume level of uttered voice of the voice command is determined to be lower than a predetermined value, receive a voice command at a voice recognition rate, which is regarding voice commands acquired by the voice command receiving unit, equal to or greater than a second threshold value that is smaller than the first threshold value.

6. The voice command receiving device according to claim 1, wherein
as a condition leading to a situation in which a voice command is not properly recognizable, the detection unit is configured to detect volume level difference between volume level of background sound of environment in which the voice command is received and volume level of uttered voice of the voice command, and
the voice command receiving unit is configured to:
when volume level of uttered voice of the voice command is determined to be higher by the volume level difference equal to or greater than a predetermined value, receive a voice command at a voice recognition rate, which is regarding voice commands acquired by the voice command receiving unit, equal to or greater than a first threshold value; and
when the volume level difference is determined to be smaller than a predetermined value or when volume level of the background sound of environment, in which the voice command is received, is determined to be greater by a difference equal to or greater than a predetermined value, receive a voice command at a voice recognition rate, which is regarding voice commands acquired by the voice command receiving unit, equal to or greater than a second threshold value that is smaller than the first threshold value.

7. The voice command receiving device according to claim 1, wherein
as a condition leading to a situation in which a voice command is not properly recognizable, the detection unit is configured to detect distance between a microphone, which acquires uttered voice of the voice command, and a person who utters the voice command, and
the voice command receiving unit is configured to:
when the detection unit determines that the distance is shorter than a predetermined distance, receive a voice command at a voice recognition rate, which is regarding voice commands acquired by the voice command receiving unit, equal to or greater than a first threshold value; and
when the detection unit determines that the distance is equal to or longer than the predetermined distance, receive a voice command at a voice recognition rate, which is regarding voice commands acquired by the voice command receiving unit, equal to or greater than a second threshold value that is smaller than the first threshold value.

8. The voice command receiving device according to claim 1, wherein, with respect to a voice command having high urgency or high immediacy, the voice command receiving unit is configured to receive the voice command at a voice recognition rate, which is regarding voice commands acquired by the voice command receiving unit, equal to or greater than a second threshold value that is smaller than the first threshold value.

9. The voice command receiving device according to claim 1, wherein
the voice command receiving device
is a recording control device used in a vehicle, and
further comprises a video data acquiring unit configured to acquire first video data taken by a first photographing unit which takes photograph of surrounding of the vehicle,
the voice command receiving unit is configured to receive an event recording instruction via a voice command, and
the implementation control unit is configured to, when the voice command receiving unit receives an event recording instruction via a voice command, store as event data the first video data capturing point of time of receiving the event recording instruction.

10. A voice command receiving method implemented in a voice command receiving device, comprising:
detecting, in an environment in which a voice command is uttered, a condition leading to a situation in which a voice command is not properly recognizable;
receiving, when it is determined to have absence of a condition leading to a situation in which a voice command is not properly recognizable, a voice command at a voice recognition rate, which is regarding the voice command, equal to or greater than a first threshold value;
receiving, when it is determined to have presence of a condition leading to a situation in which a voice command is not properly recognizable, a voice command at a voice recognition rate, which is regarding the voice command, equal to or greater than a second threshold value that is smaller than the first threshold value; and
implementing, when the voice command is received, a function with respect to the received voice command.

11. A non-transitory computer-readable storage medium storing a computer program causing a computer to execute:
detecting, in an environment in which a voice command is uttered, a condition leading to a situation in which a voice command is not properly recognizable;
receiving, when it is determined to have absence of a condition leading to a situation in which a voice command is not properly recognizable, a voice command at a voice recognition rate, which is regarding the voice command, equal to or greater than a first threshold value;
receiving, when it is determined to have presence of a condition leading to a situation in which a voice command is not properly recognizable, a voice command at a voice recognition rate, which is regarding the voice command, equal to or greater than a second threshold value that is smaller than the first threshold value; and
implementing, when the voice command is received, a function with respect to the received voice command.
